(19) United States
(12) Patent Application Publication
(10) Pub. No.: US 2014/0279421 A1
(43) Pub. Date: Sep. 18, 2014

(54) METHODS AND SYSTEMS FOR AGNOSTIC PAYMENT SYSTEMS

(71) Applicant: Elwha LLC, Bellevue, WA (US)

(72) Inventors: Pablos Holman, Seattle, WA (US); Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US)

(21) Appl. No.: 13/907,565

(22) Filed: May 31, 2013

Related U.S. Application Data
(63) Continuation-in-part of application No. 13/843,118, filed on Mar. 15, 2013.

(51) Int. Cl. G06Q 20/12

(52) U.S. Cl. CPC G06Q 20/12
USPC 705/39

(57) ABSTRACT

Computationally implemented methods and systems include acquiring an indication of one or more conditions related to a potential transaction between a vendor and a user, acquiring a vendor payment channel set, said vendor payment channel set including one or more vendor payment channels, at least one of said one or more vendor payment channels including at least one of a vendor payment option and a vendor payment modality, and adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/843,118, entitled METHODS AND SYSTEMS FOR IMPLEMENTING VARIOUS TRANSACTIONAL ARCHITECTURES, naming Pablos Holman, Roderick A. Hyde, Royce A. Levien, Richard T. Lord, Robert W. Lord, and Mark A. Malamud as inventors, filed 15 Mar. 2013 with attorney docket no. 0213-003-001-000000, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to payment systems.

### SUMMARY

In one or more various aspects, a method includes but is not limited to acquiring an indication of one or more conditions related to a potential transaction between a vendor and a user, acquiring a vendor payment channel set, said vendor payment channel set including one or more vendor payment channels, at least one of said one or more vendor payment channels including at least one of a vendor payment option and a vendor payment modality, and adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein—referenced method aspects depending upon the design choices of the system designer, and limited to patentable subject matter under 35 USC 101.

In one or more various aspects, a system includes, but is not limited to, means for acquiring an indication of one or more conditions related to a potential transaction between a vendor and a user, means for acquiring a vendor payment channel set, said vendor payment channel set including one or more vendor payment channels, at least one of said one or more vendor payment channels including at least one of a vendor payment option and a vendor payment modality, and means for adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. In addition to the foregoing, other system aspects are described in the claims, drawings, and text forming a part of the disclosure set forth herein.

In one or more various aspects, a system includes, but is not limited to, circuitry for acquiring an indication of one or more conditions related to a potential transaction between a vendor and a user, circuitry for acquiring a vendor payment channel set, said vendor payment channel set including one or more vendor payment channels, at least one of said one or more vendor payment channels including at least one of a vendor payment option and a vendor payment modality, and circuitry for adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for acquiring an indication of one or more conditions related to a potential transaction between a vendor and a user, one or more instructions for acquiring a vendor payment channel set, said vendor payment channel set including one or more vendor payment channels, at least one of said one or more vendor payment channels including at least one of a vendor payment option and a vendor payment modality, and one or more instructions for adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for acquiring an indication of one or more conditions related to a potential transaction between a vendor and a user, one or more interchained physical machines ordered for acquiring a vendor payment channel set, said vendor payment channel set including one or more vendor payment channels, at least one of said one or more vendor payment channels including at least one of a vendor payment option and a vendor payment modality, and one or more interchained physical machines ordered for adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A-1A1, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A-1A1 are stitched together in the manner shown in FIG. 1E, which is reproduced below in table format.

TABLE 1
Table showing alignment of enclosed drawings to form
partial schematic of one or more environments.

| | | | | |
|---|---|---|---|---|
| (1, 1) - FIG. 1A | (1, 2) - FIG. 1B | (1, 3) - FIG. 1C | (1, 4) - FIG. 1D | (1, 5) - FIG. 1E |
| (2, 1) - FIG. 1F | (2, 2) - FIG. 1G | (2, 3) - FIG. 1H | (2, 4) - FIG. 1I | (2, 5) - FIG. 1J |
| (3, 1) - FIG. 1K | (3, 2) - FIG. 1L | (3, 3) - FIG. 1M | (3, 4) - FIG. 1N | (3, 5) - FIG. 1O |
| (4, 1) - FIG. 1P | (4, 2) - FIG. 1Q | (4, 3) - FIG. 1R | (4, 4) - FIG. 1S | (4, 5) - FIG. 1T |
| (5, 1) - FIG. 1U | (5, 2) - FIG. 1V | (5, 3) - FIG. 1W | (5, 4) - FIG. 1X | (5, 5) - FIG. 1Y |
| (6, 1) - FIG. 1Z | (6, 2) - FIG. 1AA | (6, 3) - FIG. 1AB | (6, 4) - FIG. 1AC | (6, 5) - FIG. 1AD |
| (7, 1) - FIG. 1AE | (7, 2) - FIG. 1AF | (7, 3) - FIG. 1AG | (7, 4) - FIG. 1AH | (7, 5) - FIG. 1AI |

FIG. 1A, when placed at position (1,1), forms at least a portion of a partially schematic diagram of an environment(s) and/or an implementation(s) of technologies described herein.

FIG. 1B, when placed at position (1,2), forms at least a portion of a partially schematic diagram of an environment(s) and/or an implementation(s) of technologies described herein.

FIG. 1C, when placed at position (1,3), forms at least a portion of a partially schematic diagram of an environment(s) and/or an implementation(s) of technologies described herein.

FIG. 1D, when placed at position (1,4), forms at least a portion of a partially schematic diagram of an environment(s) and/or an implementation(s) of technologies described herein.

FIG. 1E, when placed at position (1,5), forms at least a portion of a partially schematic diagram of an environment(s) and/or an implementation(s) of technologies described herein.

FIG. 1F, when placed at position (2,1), forms at least a portion of a partially schematic diagram of an environment(s) and/or an implementation(s) of technologies described herein.

FIG. 1G, when placed at position (2,2), forms at least a portion of a partially schematic diagram of an environment(s) and/or an implementation(s) of technologies described herein.

FIG. 1H, when placed at position (2,3), forms at least a portion of a partially schematic diagram of an environment(s) and/or an implementation(s) of technologies described herein.

FIG. 1I, when placed at position (2,4), forms at least a portion of a partially schematic diagram of an environment(s) and/or an implementation(s) of technologies described herein.

FIG. 1H, when placed at position (2,5), forms at least a portion of a partially schematic diagram of an environment(s) and/or an implementation(s) of technologies described herein.

FIG. 1K, when placed at position (3,1), forms at least a portion of a partially schematic diagram of an environment(s) and/or an implementation(s) of technologies described herein.

FIG. 1L, when placed at position (3,2), forms at least a portion of a partially schematic diagram of an environment(s) and/or an implementation(s) of technologies described herein.

FIG. 1M, when placed at position (3,3), forms at least a portion of a partially schematic diagram of an environment(s) and/or an implementation(s) of technologies described herein.

FIG. 1N, when placed at position (3,4), forms at least a portion of a partially schematic diagram of an environment(s) and/or an implementation(s) of technologies described herein.

FIG. 1O, when placed at position (3,5), forms at least a portion of a partially schematic diagram of an environment(s) and/or an implementation(s) of technologies described herein.

FIG. 1P, when placed at position (4,1), forms at least a portion of a partially schematic diagram of an environment(s) and/or an implementation(s) of technologies described herein.

FIG. 1Q, when placed at position (4,2), forms at least a portion of a partially schematic diagram of an environment(s) and/or an implementation(s) of technologies described herein.

FIG. 1R, when placed at position (4,3), forms at least a portion of a partially schematic diagram of an environment(s) and/or an implementation(s) of technologies described herein.

FIG. 1S, when placed at position (4,4), forms at least a portion of a partially schematic diagram of an environment(s) and/or an implementation(s) of technologies described herein.

FIG. 1T, when placed at position (4,5), forms at least a portion of a partially schematic diagram of an environment(s) and/or an implementation(s) of technologies described herein.

FIG. 1U, when placed at position (5,1), forms at least a portion of a partially schematic diagram of an environment(s) and/or an implementation(s) of technologies described herein.

FIG. 1V, when placed at position (5,2), forms at least a portion of a partially schematic diagram of an environment(s) and/or an implementation(s) of technologies described herein.

FIG. 1W, when placed at position (5,3), forms at least a portion of a partially schematic diagram of an environment(s) and/or an implementation(s) of technologies described herein.

FIG. 1X, when placed at position (5,4), forms at least a portion of a partially schematic diagram of an environment(s) and/or an implementation(s) of technologies described herein.

FIG. 1Y, when placed at position (5,5), forms at least a portion of a partially schematic diagram of an environment(s) and/or an implementation(s) of technologies described herein.

FIG. 1Z, when placed at position (6,1), forms at least a portion of a partially schematic diagram of an environment(s) and/or an implementation(s) of technologies described herein.

FIG. 1AA, when placed at position (6,2), forms at least a portion of a partially schematic diagram of an environment(s) and/or an implementation(s) of technologies described herein.

FIG. 1AB, when placed at position (6,3), forms at least a portion of a partially schematic diagram of an environment(s) and/or an implementation(s) of technologies described herein.

FIG. 1AC, when placed at position (6,4), forms at least a portion of a partially schematic diagram of an environment(s) and/or an implementation(s) of technologies described herein.

FIG. 1AD, when placed at position (6,5), forms at least a portion of a partially schematic diagram of an environment(s) and/or an implementation(s) of technologies described herein.

FIG. 1AE, when placed at position (7,1), forms at least a portion of a partially schematic diagram of an environment(s) and/or an implementation(s) of technologies described herein.

FIG. 1AF, when placed at position (7,2), forms at least a portion of a partially schematic diagram of an environment(s) and/or an implementation(s) of technologies described herein.

FIG. 1AG, when placed at position (7,3), forms at least a portion of a partially schematic diagram of an environment(s) and/or an implementation(s) of technologies described herein.

FIG. 1AH, when placed at position (7,4), forms at least a portion of a partially schematic diagram of an environment(s) and/or an implementation(s) of technologies described herein.

FIG. 1A1, when placed at position (7,5), forms at least a portion of a partially schematic diagram of an environment(s) and/or an implementation(s) of technologies described herein.

FIG. 2A shows a high-level block diagram of an exemplary environment 200, according to one or more embodiments.

FIG. 2B shows a high-level block diagram of a personal device 220 operating in an exemplary environment 200, according to one or more embodiments.

FIG. 3, including FIGS. 3A-3B, shows a particular perspective of a potential transaction between user and client indicator acquiring module 252 of processing module 250 of personal device 220 of FIG. 2B, according to one or more embodiments.

FIG. 4, including FIGS. 4A-4D, shows a particular perspective of a vendor payment channel set including one or more of at least one vendor payment modality and at least one vendor payment option at least partial acquiring module 254 of processing module 150 of personal device 220 of FIG. 2B, according to one or more embodiments.

FIG. 5, including FIGS. 5A-5K, shows a particular perspective of an application of a user payment channel to at least one vendor payment channel of the acquired vendor payment channel set to facilitate the potential transaction module 256 of processing module 150 of personal device 220 of FIG. 2B, according to one or more embodiments.

FIG. 6 is a high-level logic flowchart of a process, e.g., operational flow 600, according to one or more embodiments.

FIG. 7A is a high-level logic flow chart of a process depicting alternate implementations of indication acquiring operation 602, according to one or more embodiments.

FIG. 7B is a high-level logic flow chart of a process depicting alternate implementations of indication acquiring operation 602, according to one or more embodiments.

FIG. 8A is a high-level logic flow chart of a process depicting alternate implementations of a payment channel set acquiring operation 604, according to one or more embodiments.

FIG. 8B is a high-level logic flow chart of a process depicting alternate implementations of a payment channel set acquiring operation 604, according to one or more embodiments.

FIG. 8C is a high-level logic flow chart of a process depicting alternate implementations of a payment channel set acquiring operation 604, according to one or more embodiments.

FIG. 8D is a high-level logic flow chart of a process depicting alternate implementations of a payment channel set acquiring operation 604, according to one or more embodiments.

FIG. 9A is a high-level logic flow chart of a process depicting alternate implementations of a payment channel adapting operation 606, according to one or more embodiments.

FIG. 9B is a high-level logic flow chart of a process depicting alternate implementations of a payment channel adapting operation 606, according to one or more embodiments.

FIG. 9C is a high-level logic flow chart of a process depicting alternate implementations of a payment channel adapting operation 606, according to one or more embodiments.

FIG. 9D is a high-level logic flow chart of a process depicting alternate implementations of a payment channel adapting operation 606, according to one or more embodiments.

FIG. 9E is a high-level logic flow chart of a process depicting alternate implementations of a payment channel adapting operation 606, according to one or more embodiments.

FIG. 9F is a high-level logic flow chart of a process depicting alternate implementations of a payment channel adapting operation 606, according to one or more embodiments.

FIG. 9G is a high-level logic flow chart of a process depicting alternate implementations of a payment channel adapting operation 606, according to one or more embodiments.

FIG. 9H is a high-level logic flow chart of a process depicting alternate implementations of a payment channel adapting operation 606, according to one or more embodiments.

FIG. 9I is a high-level logic flow chart of a process depicting alternate implementations of a payment channel adapting operation 606, according to one or more embodiments.

FIG. 9J is a high-level logic flow chart of a process depicting alternate implementations of a payment channel adapting operation 606, according to one or more embodiments.

FIG. 9K is a high-level logic flow chart of a process depicting alternate implementations of a payment channel adapting operation 606, according to one or more embodiments.

FIG. 9L is a high-level logic flow chart of a process depicting alternate implementations of a payment channel adapting operation 606, according to one or more embodiments.

FIG. 9M is a high-level logic flow chart of a process depicting alternate implementations of a payment channel adapting operation 606, according to one or more embodiments.

FIG. 9N is a high-level logic flow chart of a process depicting alternate implementations of a payment channel adapting operation 606, according to one or more embodiments.

FIG. 9P (note that there is no FIG. 9O to avoid confusion as Figure “ninety”) is a high-level logic flow chart of a process depicting alternate implementations of a payment channel adapting operation 606, according to one or more embodiments.

FIG. 9Q is a high-level logic flow chart of a process depicting alternate implementations of a payment channel adapting operation 606, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for acquiring an indication of one or more conditions related to a potential transaction between a vendor and a user, acquiring a vendor payment channel set, said vendor payment channel set including one or more vendor payment channels, at least one of said one or more vendor payment channels including at least one of a vendor payment option and a vendor payment modality, and adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 105 is shown/described herein, e.g., in FIGS. 1, 2, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, devices that are associated with one or more users, e.g., phones, tablets, laptops, desktops, cars, game systems, appliances, and the like, may collect data regarding the user. This data may be desired by third parties. The following describes, among other implementations, methods and systems of managing user data collected by one or more devices that may also be useful to entities that are not the user, and which entities may not necessarily have access to the data.

This application uses the words “user” and “client” interchangeably, to further underscore the intention that “user “may not necessarily be a person, but any entity that has a relationship with the vendor. The use of the word “client” does not impute any relationship between the entity and the vendor other than the potential for an exchange of goods and/or services for compensation between the client and the vendor.

Referring now to FIG. 1, FIG. 1 illustrates an exemplary system environment in which one or more methods, systems, circuitry, articles of manufacture, and computer program products and architecture, in accordance with various embodiments, may interoperate. FIG. 1 may show one or more systems that may operate in coordination or independently. One or more portions of systems in FIG. 1 may operate as a complete system, or as a component of a larger system.

Referring now to FIG. 1, FIG. 1 shows a payment initiation module 2210. The payment initiation module may be part of user device 120, or may be a separate device. Payment initiation module 120 may be any module that detects a user's intention to carry out one or more transaction. The detection of a user's intention to carry out one or more transactions may be relayed from another device, may be inferred, directly or indirectly, from user input, may be inferred from user action (e.g., a user places an item in a shopping cart, or pours a cup of coffee, or takes a bottle of wine off of a shelf), may be initiated by a person that is observing the user or otherwise interacting with the user (e.g., a barista at a coffee shop, or a technician in a mobile device store). In an embodiment, this module may be designed to provide the user with a seamless interface, e.g., the displaying of a “pay now” button, which will be described in more detail herein with respect to the “context sensitive pay button branch” observable extending to the left of payment initiation module 2210 in the context of FIG. 1. It is noted that the direction here and in other places throughout FIG. 1 was chosen merely for illustrative purposes and has no bearing or effect on the operation of the various modules and/or components of FIG. 1.

Referring again to FIG. 1, in an embodiment, payment initiation module 2210 may include payment initiation exemplary module 2210A, which is illustrated as a module that is designed to carry out an exemplary, non-limiting example embodiment, specifically, that a user desires to pay for an item that the user has selected at a store. In an example, the user has selected a bottle of wine, for which the user desires to pay. In this example, the user is in a wine store, but in another example, the store could be virtual, and the user could be in their home or at another location browsing a virtual store on a computer, tablet, mobile phone, or other device.

In an embodiment, payment initiation module 2210 may include simple payment initiation module 2210B. Simple payment initiation module 2210 may initiate a simplified payment branching module, in which a user wants to pay for an item, or determine how much an item costs, or determine whether there is enough money (e.g., cash or cash equivalents, e.g., points, rewards, rebates, coupons, tokens, etc.) in one or more accounts e.g., an item the user has taken a picture of, or placed in a cart, or grabbed, or poured, e.g., coffee in a coffee shop or soda out of a soda dispenser, and the action initiates payment, or a negotiation for payment, for the item or service. In an embodiment, a user may be wearing augmented reality glasses, and may look at an item and make some sort of hand, eye, or bodily gesture (e.g., waving the hand across the face), or speak a particular command or set of words, that indicates that the user desires to pay for an item. In an embodiment, the payment initiation may be a time based event, e.g., the start of a movie, if a user has gotten concessions from an usher or a popcorn stand, or the like, or the start of a round or an inning of a sporting event, e.g., a baseball game. In an embodiment, the details of the payment channel negotiation, either for modality, option, or both, may be hidden from the user as the completion of a transaction. In an embodiment, there may be a fixed system, e.g., a user may go to a video arcade, and receive twenty tokens worth of credits, and the simple payment initiation occurs each time the user performs an action that debits a token, until the tokens are expended.

In an embodiment, a user may be placed in an environment where the user is allowed to select multiple items, products, or services, up to a limit, which may be time, credit, money, or token-based, e.g., a buffet, or a payment for five minutes in an electronics store, or a payment that allows a user to select twenty different resistors from a bin at an electronics store, e.g., a Radio Shack. In such an embodiment, the payment initiation module may handle the negotiation of payment and alert the user when the limit has been reached.

In an embodiment, the details of how the payment is negotiated are hidden from the user. For example, the manner in which the vendor acquires payment, e.g., whether over a Wi-Fi network, or the equivalent scanning of a bar code, or the entry of a PIN number, may be obscured from the user, who may receive simplified information indicating the success or failure of the transaction, or, in an embodiment, less information than that.

In an embodiment, as shown in FIG. 1, payment branching may lead to one or more portions of a user device 120 (e.g., following the red arrow “south” or “downward”). User device 120 may include, among other elements, a device memory 126. Device memory 126 may store one or more of a user payment option set and a user payment modality set.

In an embodiment, “payment” may refer to any portion of a transaction between a user and a vendor, including the selection and/or identification of an item and/or a service. As a tangible example, the scanning of a barcode on a can of peaches at a grocery store may be part of the “payment.” As another example, a barista keying in a description of a coffee order from a user into a computing device may also be part of a “payment.” Payment may also include authentication of a user to determine a user is the entity that the user is claiming to be. Payment is used merely as a convenient shorthand to refer to the entire process from start to finish of the acquisition of one or more goods and/or services by a user, and is not intended to be limited to the point of the transaction in which money and/or money equivalents change possession from the user to the vendor.

Under the terminology of this application, “payment modality” may refer to the mechanic by which payment information is exchanged between the vendor and the user. “Payment option” refers to the type of payment utilized by the user, and may refer to a type of credit card, a type of debit card, a type of electronic currency, and the like. The term “payment channel” may refer to one or both of “payment modality” and “payment option.”

Referring again to FIG. 1, FIG. 1 shows exemplary payment options 2120. Exemplary payment options 2120 are not intended to be an exhaustive list, but merely exemplary of some of the various types of payment options. For example, exemplary payment options 2120 may include one or more of credit card A 2122 (e.g., which may be a credit card that includes travel rewards, e.g., discounts on travel expenses), credit card B 2124 (e.g., which may be a card that accumulates fuel purchasing rewards, e.g., discounts on gasoline expenses), personal debit card 2126, corporate credit card 2128, PayPal account 2132, frequent shopper rewards card 2134, gift certificate 2136 (e.g., which could refer to a specific gift certificate, e.g., “ten dollar Starbucks card” that can be redeemed only at a particular vendor, or a generic gift certificate, e.g., an “American Express gift card,” that is valid and redeemable regardless of the vendor, or a combination of the two, e.g., a gift card good at any hardware store, or any store in the downtown area of a city), instant credit approval 2138, cash 2142, foreign currency 2144, and cash equivalents 2146.

Referring again to FIG. 1, FIG. 1 shows exemplary payment modalities 2320. Exemplary payment modalities 2320 are not intended to be an exhaustive list, but merely exemplary of some of the various types of payment modalities. For example, exemplary payment modalities 2320 may include one or more of virtual currency (e.g., BitCoins, or Xbox points, and the like) 2366, one-dimensional (1-D) barcode scan 2358, credit card with swipe only 2322, credit card with swipe and personal identification number (PIN) entry 2324, biometric retinal scan 2338, biometric fingerprint scan 2342, two-dimensional (2-D) barcode scan 2356, color barcode scan 2362, credit card with swipe and signature 2325, device tap, e.g., near field communication technology 2332, audio speech recognition (e.g., identifying the words that are spoken) 2344, audio voice recognition (e.g., identifying the speaker that has spoken, e.g., voiceprint analysis, or other voice identification techniques) 2346, PIN and/or password only 2352, trusted device voucher 2354, device authentication over a wireless network 2334, device authentication over a cellular network 2336, credit card proximity (e.g., via Radio-Frequency Identification (RFID)) 2326, credit card microchip 2364, electronic funds transfer 2368, device proxy 2348 (e.g., where another, more complex device performs one or more steps in completing the payment process), and three-dimensional object identification 2372.

As shown in FIG. 1, exemplary payment options 2120 and exemplary payment modalities 2320 are illustrated as “clouds” in the drawings. This is to indicate that the payment options and the payment modalities can be substituted anywhere in the system without substantially changing the system. Specific examples may be given with specific payment options and payment modalities, but substitution with other options and/or modalities, whether listed as exemplary in this application or not listed, will not substantially change the operation of this architecture and should be considered as within the scope of this invention.

Referring again to FIG. 1, user device 120 may include user payment channel obtaining module 2240. User payment channel obtaining module obtains the various user payment channels through one or more techniques, whether retrieving from device memory, scanning the device, polling different portions of the device, receiving and/or retrieving data from a remote location, or a combination of these. Payment channel obtaining module 2240 also may be dynamic, e.g., may determine that Wi-Fi is not available as a payment modality if there is no available open wireless network. Similarly, a user may disable various modalities, e.g., a user may want to stop using Credit Card A at a particular time, for example, if the user is approaching a credit limit. Payment channel obtaining module 2240 may include one or more of user payment option set obtaining module 2220 and user payment modality set obtaining module 2230. User payment option set obtaining module 2220 may be configured to obtain the payment option set for that user under a particular set of conditions, or generally. Similarly, user payment modality set obtaining module 2230 may be configured to obtain the payment modality set for that user under a particular set of conditions, or generally.

In an embodiment, user payment option set obtaining module 2220 may include user payment option set receiving module 2222. User payment option set receiving module 2222 may receive a user payment option set from a location. In an embodiment, the user payment option set, e.g., an exemplary user payment option set 3010A, may be received from cloud storage, e.g., network storage, e.g., user payment channel set cloud storage module 3010. User payment channel set cloud storage module 3010 may be any form of storage that is remote to user device 120, regardless of the owner of the network space, or the characteristics of the space, e.g., shared, dedicated, specific, and the like.

In an embodiment, user payment option set receiving module may receive a user payment option set, e.g., exemplary user payment option set 3020B, from a user payment channel set home/enterprise server storage module 3020. Module 3020 may be a home server, for example, or may be a related device to a device carried by a user. For example, user device 120 may be a watch, or a pair of glasses, that provides functionality to a user, whereas a payment option set is stored on a phone device carried by the user, or on a phone device carried by a related user, e.g., a user's mother, classroom teacher, boss, and the like.

In an embodiment, user payment channel obtaining module 2240 may include one or more of user payment option set receiving module 2222, user payment option set retrieving module 2224, and user payment option set generating module 2226. In an embodiment, user payment modality set obtaining module 2230 may include user payment modality set receiving module 2232, user payment modality set retrieving module 2234, and user payment modality set 2236. In an embodiment, one or more of these modules may work together to obtain one or more of the user payment option set and the user payment modality set. It is noted here that “set” may include a set of one payment option, or a set of one payment modality, or an empty set (e.g., there are no available payment options under the current conditions). It is further noted that “set” implies any structure, e.g., data structure, capable of representing, storing, manipulating, transmitting, conveying, displaying, or otherwise acting upon or for data.

In an embodiment, the user payment channel obtaining module 2240 obtains the user payment channel. Referring again to FIG. 1, as an example, the obtained user payment channel set, e.g., obtained user payment channel 2260, may include user payment option set 2262 and user payment modality set 2264. It is noted that these are merely exemplary user payment option sets and user payment modality sets, and other embodiments may include other sets of various size and content. Also, although the user payment option set 2262 and the user payment modality set 2264 are illustrated separately, this is merely for ease of understanding and illustration. In an embodiment, there may be a single set that includes part or all of a user payment option set and a user payment modality set, or multiple sets that contain one or more portions of one or more of the user payment option set and the user payment modality set.

In an embodiment, the obtained user payment channel set 2260 may include user payment option set 2262. As an example, and merely for the purposes of illustration, user payment option set 2262 may include credit card A 2122 and personal debit card 2126. In an embodiment, the obtained user payment channel set 2260 may include user payment modality set 2264. As an example, and merely for the purposes of illustration, user payment modality set 2264 may include device tap near-field communication 2332 and audio-voice 2346.

In an embodiment, user device 120 also may include vendor payment channel obtaining module 2410. Although pictured as part of user device 120, this is merely for illustrative purposes. In another embodiment, user device 120 may be external to user device 120, or may communicate over any form of network or any other form of communication. Moreover, vendor payment channel obtaining module 2410 may be interpreted in the illustration as operating after user payment channel obtaining module 2240. In an embodiment, vendor payment channel obtaining module 2410 may operate after user payment channel obtaining module 2240. In other embodiments, vendor payment channel obtaining module 2410 may operate concurrently or before, or on a different thread, processor, device, or system, as user payment channel obtaining module 2240.

In an embodiment, vendor payment channel obtaining module 2410 may include a vendor interface module 2412. Vendor interface module 2412 may be configured to receive a transmission of one or more vendor payment options and/or one or more vendor payment modalities. For example, in an embodiment, vendor interface module 2412 receives a broadcast from vendor device 6100, e.g., vendor payment channel set broadcasting module 2612. In an embodiment, obtained vendor payment channel sets 2460 may include vendor payment option set 2462 and vendor payment modality set 2464.

In an embodiment, vendor payment channel obtaining module 2410 may include vendor interface retrieving module 2414. Vendor interface retrieving module 2414 may retrieve one or more portions of one or more of the vendor payment option set, e.g., vendor payment option set 2462, and vendor payment modality set 2464. In an embodiment, vendor interface retrieving module 2414 may include vendor interface retrieving from vendor module 2416 and vendor interface retrieving from trusted device module 2418. In an embodiment, vendor payment channel obtaining module 2410 may include one or more of vendor payment channel determining module 2422 and vendor payment channel detecting module 2424.

In an embodiment, vendor payment channel obtaining module 2410 may include vendor scanning module 2430. In an embodiment, vendor scanning module 2430 may be configured to use one or more tools, e.g., hardware, software, or a combination thereof, to scan the surroundings of the user device 120, or to scan related networks for information about the surroundings of user device 120, in order to obtain information about one or more vendor payment channel sets. For example, vendor scanning module may acquire information through various forms, as indicated in module 2430A. For example, the user device may acquire data about vendor payment channels from one or more trusted devices, one or more devices in the proximity that are sharing or willing to share data, through Internet network resources (e.g., social networks, e.g., Twitter, Facebook, and the like), through one or more specific databases that may be proprietary and may be provided by one or more manufacturers of devices and/or device operating systems, e.g., Apple, Inc.

In an embodiment, module 2430 may include one or more databases which may be read by vendor scanning module 2430. With respect to module 2430, the “database” may be replaced with any data structure, or may represent data that is scattered across one or more networks and collected by one or more services, which may or may not be acting under the direction of user device 120. For example, module 2430 may include vendor information proprietary database 2431A, vendor information from search engine/data repository 2431B, vendor information from polling/querying area devices 2431C, vendor information from polling/querying trusted devices 2431D, and vendor information from publicly available data 2431E. In an embodiment, one or more of these or other sources may be used to obtain a vendor payment option set and/or a vendor payment modality set.

In an embodiment, vendor payment channel obtaining module 2410 may obtain one or more vendor payment channel sets 2460. In an embodiment, and for exemplary and/or illustrative purposes only, vendor payment channel set 2460 may include vendor payment option set 2462 and/or vendor payment modality set 2464. In an embodiment, and only for exemplary purposes, vendor payment option set 2462 may include credit card A 2122 and cash 2142. In an embodiment, and only for exemplary purposes, vendor payment modality set 2464 may include credit card swipe+PIN 2324 and credit card swipe+signature 2325. In an embodiment, this information may be gathered by vendor scanning module 2430, which, in an embodiment, may query the vendor's network to determine which modalities of payment are recognized. In an embodiment, the vendor scanning module 2430 may use false data to sample the systems of the vendor, to determine what capabilities for modalities and payment options are possessed by the vendor.

In an embodiment, when the user payment channel set and the vendor payment channel sets have been obtained, then, in an embodiment, payment option comparator module 2500 and payment modality comparator module 2700 may compare the vendor payment option set and the vendor payment channel set, respectively. In the illustrated embodiment, payment option comparator module 2500 and payment modality comparator module 2700 are shown as separate modules, however, in other embodiments, they may be the same module, or scattered across various devices, or integrated into device 120. In an embodiment, a programmable chip, e.g., a central processing unit, or a portion thereof, may act as both payment modality comparator module 2700 at time A and payment option comparator module 2500 at time B. In an embodiment, payment option comparator module 2500 and payment modality comparator module 2700 may be a part of user device 120.

Referring again to FIG. 1, payment option comparator module 2500 may receive the vendor payment option set 2504 and the user payment option set 2506. In an embodiment, payment option comparator module 2508 may compare all or a portion of vendor payment option set 2504 and the user payment option set 2506. It is noted that the sets may be traversed in any known manner or form for comparison, and it is not required that the entire set of either the vendor payment option set 2504 or the user payment option set 2506 be traversed in their entirety. In an embodiment, payment option comparator module 2508 may receive user preference input 2520 and/or vendor preference input 2522, which may suggest an order in which the payment option or options are to be ranked, categorized, selected, or otherwise preferred, relative to one another or generally. Input from these modules is optional and may vary from system to system.

In an embodiment, payment option comparator module 2508 may determine that there is an overlap between vendor payment option set 2504 and user payment option set 2506. In an embodiment, overlapping set detection module 2510 may generate a calculated overlapping set 2535. It is noted that overlapping set 2535 is not required to be the entire overlapping set 2535. For example, in an embodiment, payment option comparator module 2508 may stop as soon as payment option comparator module finds one match, and that single match becomes the calculated overlapping set 2535, regardless of whether there are additional overlapping sets.

In an embodiment, payment option comparator module 2508 may determine that there is no overlap between vendor payment option set 2504 and user payment option set 2506. In an embodiment, no overlap in set detection module 2512 may transfer control to no-overlap interfacing module 2530. In an embodiment, if no overlap is detected between the vendor payment option set 2504 and the user payment option set 2506, then the no-overlap interfacing module 2530 may branch to a payment option interfacing module 2550.

For example, for exemplary purposes, in the illustrated example, “Credit Card A” is found both in the vendor payment option set 2504 and the user payment option set 2506. Thus, in an embodiment, overlapping set detection module 2510 may be invoked, and calculated overlapping set 2535 may include the set of “Credit Card A.” In another embodiment, however, if there is no overlap, then payment option interfacing module 2550 may be invoked.

In an embodiment, payment option interfacing module 2550 may be part of user device 120. In an embodiment, payment option interfacing module 2550 may partially be a part of user device 120, and partially exterior or external to user device 120. In an embodiment, payment option interfacing module 2550 may include payment option supplier contact module 2552. In an embodiment, payment option supplier contact module 2552 may contact one or more payment option administrators to determine if the user's payment option set 2506 can be expanded to include a payment option that is part of the vendor's payment option set. For example, in an embodiment, payment option supplier contact module 2552 may contact the administrator of one or more of the vendor's payment options, to see if the administrator of the payment option (e.g., the credit card company, e.g., Visa) may grant the user access to their payment system, either temporarily, as in a one-use credit card, or permanently, e.g., the granting of a persistent credit line to the user. In an embodiment, payment option supplier contact module 2552 may contact an electronic payment supplier, e.g., PayPal, or Amazon Payments, and request a one-use username and password that the user can use to interact with the vendor system, and then the electronic payment supplier can interface with one of the user payment options to receive reimbursement for processing the transaction with the vendor's payment option.

In an embodiment, payment option interfacing module 2550 may include manufacturer store as intermediary payment option module 2554. For example, in an embodiment, the manufacturer store as intermediary payment option module 2554 may contact an administrator of an online store, e.g., the Apple store, and determine if the Apple store will act as an intermediary to charge the device using its payment systems that are in place, and then handling the payment to the vendor.

In an embodiment, payment option interfacing module 2550 may include related device as intermediary payment option module 2556. For example, in an embodiment, related device as intermediary payment option module 2556 may find a related device that will pay for the item for the user. A related device may be a device that is in the user devices' contact list, or a device that is close to the user, or a device that is on a predetermined list that was approved by the device user, or a device that shares one or more characteristics with the user, or a device for which the same entity is responsible for paying the operating costs. For example, in an embodiment, if the user device 120 that is involved in the transaction is operated by a minor, then the minor's parent's device may be a related device, and may have additional payment options that can be used to interface with the vendor, on behalf of the minor.

In an embodiment, related device as intermediary payment option 2556 may include one or more of a contact list device search module 2558, a proximity device search module 2560, and/or a same-contract device search module 2562. One or more of these modules may be used to find a related device through one or more various methods, or through other methods not detailed here (e.g., through a social network accessed by the user device).

In an embodiment, payment option interfacing module 2550 may include unrelated device as intermediary payment option module 2564, which, in an embodiment, may include contracting device search module 2566 that is configured to search for devices that will take on a contract to assist the user device. For example, a person unrelated to the user may authorize their device to act as a payment intermediary. This intermediary could be nonspecific, could be specific to a store (e.g., only assist for Kohl's), could be specific to a type of stores (e.g., only assist for grocery stores), could be context-dependent (e.g., only assist for a store the device owner is currently located in, or only authorize their device to act as payment intermediary for certain user payment option types (e.g., only assist for cash transactions. The user of the unrelated device, and the unrelated device, would then bear all or a part of the burden for negotiating reimbursement from the user device, plus whatever fee is allowed or negotiated, either by the unrelated device, by the vendor, by a third party, or by a governmental entity.

In an embodiment, payment option interfacing module may include selected payment option interface transmitting module 2568, which may be configured to transmit the selected payment option, and/or one or more details about the logistics of the payment option, to the device 120. It is noted that this transmission may be virtual or internal to the device 120, and may not include an actual “transmission,” but merely a handling of data.

In an embodiment, payment option comparator module 2500 may result in a selected payment option 2480, which, in an embodiment, and solely for exemplary purposes, may be credit card A 2122.

In an embodiment, payment modality comparator module 2700 may result in a selected payment modality 2490. Referring again to FIG. 1, in an embodiment, payment modality comparator module may include modality comparator exemplary module 2702, which may be configured to determine whether there is any overlap between the user payment modality set and the vendor payment modality set. In an example, e.g., the example shown in FIG. 1, exemplary vendor payment modality set 2704 may include credit card swipe+PIN 2324 and credit card swipe+signature 2326.

In an embodiment, payment modality comparator module 2700 may include payment modality comparator module 2708. Referring again to FIG. 1, payment modality comparator module 2700 may receive the vendor payment modality set 2704 and the user payment modality set 2706. In an embodiment, payment modality comparator module 2708 may compare all or a portion of vendor payment modality set 2704 and the user payment modality set 2706. It is noted that the sets may be traversed in any known manner or form for comparison, and it is not required that the entire set of either the vendor payment modality set 2704 or the user payment modality set 2706 be traversed in their entirety. In an embodiment, payment modality comparator module 2708 may receive user preference input 2720 and/or vendor preference input 2722, which may suggest an order in which the payment modality or modalities are to be ranked, categorized, selected, or otherwise preferred, relative to one another or generally. Input from these modules is optional and may vary from system to system.

In an embodiment, payment modality comparator module 2708 may determine that there is an overlap between vendor payment modality set 2704 and user payment modality set 2706. In an embodiment, overlapping set detection module 2710 may generate a calculated overlapping set 2735. It is noted that overlapping set 2735 is not required to be the entire overlapping set 2735. For example, in an embodiment, payment modality comparator module 2708 may stop as soon as payment modality comparator module finds one match, and that single match becomes the calculated overlapping set 2735, regardless of whether there are additional overlapping sets.

In an embodiment, payment modality comparator module 2708 may determine that there is no overlap between vendor payment modality set 2704 and user payment modality set 2706. In an embodiment, no overlap in set detection module 2712 may transfer control to no-overlap interfacing module 2730. In an embodiment, if no overlap is detected between the vendor payment modality set 2704 and the user payment modality set 2706, then the no-overlap interfacing module 2730 may branch to a payment modality interfacing module 2640.

In an embodiment, e.g., in an illustrated example as shown in FIG. 1, there may be no overlap between exemplary vendor payment modality set 2704 and exemplary user payment modality set 2706. Thus, in an embodiment, no-overlap interfacing module may interface with payment modality interfacing module 2640, which may be part of device 120, separate from device 120, or a portion of which may be a part of device 120.

In an embodiment, payment modality interfacing module 2640 may include payment modality user-device as broker module 2650. In an embodiment, payment modality user-device as broker module 2650 facilitates the interface between a user payment modality and a vendor payment modality. For example, payment modality user-device as broker module 2650 may include vendor-accepted modality selecting module 2654 that is configured to select a modality that is acceptable to the vendor and that the device can broker. For example, the vendor may require a credit card swipe and PIN number as a modality. The user may have “audio-voice” as a modality because he or she does not want to physically swipe their card at a station. Thus, the device may act as a broker between the two modalities. Vendor-accepted modality selecting module 2654 may determine that, because it has a microphone to record and convert the PIN, and access to a credit card database, the device can act as a broker between the two modalities.

For example, payment modality user-device as broker module 2650 may include modality adaptation module 2654, which may be configured to take one or more steps in facilitating “conversion” of one modality supported by the device into another. This may be transparent to the user, or may require user assistance. In an embodiment, e.g., the illustrated embodiment, in step 2654EX1, the device may request the user to use the audio—voice modality to speak a PIN number into the microphone of the device, which is recorded. In an embodiment, in step 2654EX2, the device may convert the inputted audio into a PIN number in the format accepted by the vendor. In an embodiment, in step 2654EX3, the credit card data corresponding to a magnetic strip swipe data may be retrieved from a credit card database, e.g., a database run by the credit card company.

In an embodiment, payment modality user-device as broker module 2650 may include converted modality interfacing module 2656, which acts to transmit the converted swipe data and the PIN to the vendor, which treats the transaction as if the user had swiped his or her card and entered his or her PIN data.

In an embodiment, payment modality interfacing module 2640 may include payment modality related-device as broker module 2660. In an embodiment, payment modality related-device as broker module 2660 may include vendor-accepted modality selecting module, which selects one or more of the vendor modalities (for which there is no overlap) that the device is capable of brokering with assistance from another device. In an embodiment, payment modality related-device as broker module 2660 also may include criterion-meeting related device acquiring module 2662, which may use one or more search techniques to find a related device that can assist the user device in completing the transaction. The search for a related device may be similar to that described above.

In an embodiment, criterion-meeting related device acquiring module 2662 may include one or more of contact list device search module 2662A, proximity device search module 2662B, predetermined device search module 2662C, and same-contract device search module 2662D.

In an embodiment, payment modality related-device as broker module 2660 may include related device instructing module 2664, which may be configured to instruct the related device found by module 2662 regarding how to interface the vendor modality with the user device. In an embodiment, this may include transmitting payment information to the related device so that the related device may engage the vendor modality.

In an embodiment, payment modality interfacing module 2640 may include payment modality vendor equipment as broker module 2670. In an embodiment, a vendor may provide equipment, which may be third-party produced, that allows additional modalities. For example, an internet currency provider (e.g., BitCoin) may outfit various Starbucks with devices that allow BitCoin transactions to be processed, using the device as an intermediary, without changing the Starbucks infrastructure. A user device may find these broker devices (which may not be implemented entirely in hardware) and use them to facilitate transactions, and may be invisible to the end user.

In an embodiment, payment modality vendor equipment as broker module 2670 may include vendor equipment communication module 2672. In an embodiment, payment modality vendor equipment as broker module 2670 may include vendor equipment interfacing module 2674. In an embodiment, payment modality vendor equipment as broker module 2670 may include data transmission to vendor equipment module 2676. In an embodiment, payment modality vendor equipment as broker module 2670 may include transaction monitoring module 2678.

In an embodiment, payment modality interfacing module 2640 may include payment modality unrelated device as broker module 2680. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner), similarly to the unrelated device as intermediary payment option module 2564.

In an embodiment, payment modality interfacing module 2640 may include selected payment modality interface transmitting module 2568, which may transmit the selected payment modality, which in an embodiment, the transmission may be internal to the device or within the workings of a particular application or module.

In an embodiment, the selected payment modality 2490 may be paired with the selected payment option into a selected payment option and modality. The combination may not be literal; it may be as simple as setting a flag indicating that a payment option and a payment modality have been selected. In an embodiment, the combination is omitted entirely, and shown in the illustration simply for ease of understanding the illustrated system.

In an embodiment, payment executing module 4000 may be a portion of the user device 120, or separate from the user device 120. Payment executing module 4000 may include vendor contacting module configured to contact the vendor to apply the payment. In an embodiment, payment executing module 4000 may include intermediary utilization applying module 4020, which may be configured to use any intermediaries, e.g., other devices, e.g., vendor devices, other user devices, other user's devices that are either related or unrelated to the user device, and the like, to assist in the carrying out of the payment.

In an embodiment, payment executing module 4000 may include intermediate steps module 4030, which may be used, for example, to convert one modality to the other, payment transmission module 4040 which may be used to transmit the payment using the selected modality, and confirmation receipt module 4050 which may communicate with the vendor to receive confirmation that the payment has been accepted.

Referring again to FIG. 1, in an embodiment, the payment initiation module may include a persistent payment button on the device 2210C. In an embodiment, persistent payment button 2210C may represent a button that allows the user to pay, that does not change based on changing payment channels. It does not necessarily mean that the button is always present, although that may be the case in an embodiment. Persistent payment button 2210C may be a soft key or a hard key and may have a distinctive design or shape, and may be designed to be easy to access, in an embodiment. In an embodiment, persistent payment button 2210C may be a persistent payment soft button 7510. In an embodiment, the persistent payment soft button 7510 may be built into the device firmware. In another embodiment, the persistent payment soft button 7510 may be built into the operating system, or into another component or module of the device. In an embodiment, persistent payment button 2210C may be a physical, e.g., a hard button that is built into the device. For example, persistent payment button 2210C may be implemented as a persistent payment hard button 7512 that is built into the device. In another embodiment, persistent payment hard button 7512 may be programmed to operate as a persistent payment button under particular conditions, e.g., when a particular module is active, or when a particular condition is met. In an embodiment, for example, one or more devices with a persistent payment hard button 7512A may be provided when a user enters a retail store. For example, a wholesale superstore, e.g., a Wal-Mart, may hand out user devices having a persistent payment hard button 7512A to users as they enter the store, in order to facilitate one or more transactions.

In an embodiment, a module 2250 displays a single pay button on the user device. In an embodiment, module 2250 may include condition checking module 7522. Condition checking module 7522 may check one or more conditions to determine, e.g., when a particular module is active, or whether a particular condition is met. In an embodiment, module 2250 may include vendor communication maintaining module. Vendor communication maintaining module 7524 may include a communication module for communicating with the vendor through one or more networks or other media. For example, a user device may communicate with the vendor through a closed vendor network, or through a wireless network provided by the vendor, or through a 4G LTE network provided by an unrelated communication network provider. In an embodiment, module 2250 may include payment channel monitoring module 7526. Module 7526 may monitor one or more payment channels of the user, the user device, or the vendor, and update if one or more of the monitored payment channels changes or becomes active or inactive.

In an embodiment, an input receiving module 7530 may receive input from the persistent payment button 2210C. For example, module 7530 may include button pushing receiving module 7532, which may detect when the persistent payment button 7532 is pressed. In another embodiment, however, persistent payment button 2210C may not be a button, but some other sort of non-button trigger, e.g., a gesture made while operating an augmented reality device, or an infrared signal. In an embodiment, non-button interface receiving module 7532 of input receiving module 7530 may receive the input indicating a potential transaction from the non-button implementation of the persistent payment button.

Then, in an embodiment, using methods previously described, a vendor payment channel acquiring module 2252 acquires an indication that the persistent payment button has been activated, and acquires, e.g., detects, receives, retrieves, or otherwise obtains, the vendor payment channel, e.g., using the vendor payment channel detecting module 2254, partly to detect the vendor payment channels. In an embodiment, vendor payment channel detecting module 2254 may access one or more external resources 2280, as previously described. Specifically, in an embodiment, vendor payment modality and option application module 2256 may apply the selected payment modality and option to execute the user's request to initiate payment, using the persistent payment button, and transparently, or partially transparently to the user, with the context of the device (e.g., location, and other factors) determining what specifically the persistent payment button carries out. In an embodiment, vendor payment channel acquiring module 2252 may include vendor transmission of payment options and/or payment modalities receiving module 7528, which may receive one or more payment options and/or one or more payment modalities from the vendor.

In an embodiment, multi-purpose device 7500 may also include an automated user payment channel selection module 7540, which, in an embodiment, may select a user payment channel for use in carrying out at least a portion of the transaction. In an embodiment, the selection may occur without user intervention. In another embodiment, the selection may include user intervention. Module 7540 may include one or more of payment channel comparator module 7542, weighted payment channel selecting module 7544, and payment channel selecting with non-user external automated input module 7546, which may select a user payment channel automatically, e.g., without further user input after the transaction has been initiated. In an embodiment, e.g., with the use of input module 7546, the process of selecting a user payment channel may be influenced or directly controlled by an external resource, which may or may not be related to the user or the user device.

In an embodiment, multi-purpose device 7500 may include selected automated user payment channel adaptation to one or more vendor payment channel modules 7550. For example, in an embodiment, module 7550 may include vendor payment modality and option application module 2256 may include external resource for payment channel utilizing module 2258, which may be configured to use one or more external resources to complete payment using a context-dependent vendor channel, e.g., through one or more external resources 2280.

In an embodiment, multi-purpose device 7500 may include potential transaction facilitating module 7560, which may include one or more communication modules for communicating with the vendor for which the potential transaction is being negotiated. In an embodiment, potential transaction facilitating module 7650 may include vendor payment systems communication module 7562.

In an embodiment, multi-purpose device 7500 may be implemented with one or more options or modifications. For example, in an embodiment, multi-purpose device 7500 may be implemented as described in payment option hard cap limiter 7520A. In that example, a user has more goods in his or her shopping cart than what he or she has funds to pay with using one or more user payment options of the user payment channel set. Using payment option hard cap limiter 7520A, a user may take items out of his or her shopping cart (which may exist in any known implementation, whether virtual or real), until a signal, e.g., the payment button changes or lights up, or some other appropriate signal, indicating that there are enough funds in the account to pay for the items.

In an embodiment, multi-purpose device 7500 may be implemented as payment option soft cap limiter example 7520B. For example, in an embodiment, a user may add things to his or her shopping car (again, which may be virtual or physical) until the button goes out, indicating he has overstepped how much funds are in the account, or how many funds have been allocated from the account for this purpose. For example, this could be implemented as a type of budgetary control (e.g., only allowed to spend up to $50 per month at Best Buy), or could be used by parents/spouses/siblings etc. to control spending (e.g., “my thirteen year old son can access my account to pay for things when he is at the comic book store today, but only up to twenty-five dollars).

In an embodiment, multi-purpose device 7500 may be implemented as gift car usage maximizer 7520C. For example, in an embodiment, a user may have an undetermined amount of value remaining on a gift card and the pay button may illuminate or otherwise change shape, form, status, or similar appearance when the items reach a certain value that is close to the total value of the gift card. For example, the payment bar could be realized in multi-colors, e.g., red and green, and the amount of green in the button indicates how much of the gift card would be utilized by the purchases currently in the shopping cart.

In an embodiment, multi-purpose device 7500 may communicate with a retail store front, e.g., retail store front 7570. In an embodiment, a device with a “pay” button, e.g., device 2121, may interface with the retail store front 7570. In an embodiment, a retail store front 7570 may include a receiving one or more devices configured to have a button that interacts and/or responds to the retail vendor module 7572, a distributing the one or more devices to one or more users upon entry to the retail dressage module 7574, communicating with the one or more devices to change the button status based on one or more conditions module 7578 (e.g., it is noted that, in an embodiment, this module may be assisted by or controlled entirely by an external third party), and a facilitating one or more transactions in response to button pressing module 7579. In an embodiment, the modules listed above may be performed by a third party that is not the user or the vendor, but may or may not be related to one or both.

Referring again to FIG. 1, in an embodiment, payment initiation module 2210 may include simple payment initiation module 2210B, which may allow for simple payment of one or more items that the user has indicated. For example, a user wants to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option. The initiation could also be a time-based event, e.g., the start of a movie, or of a round of a fight, or an inning of a baseball game (e.g., for purchase of concessions).

In an embodiment, there may be an augmented reality device 4100. Augmented reality device 4100 may be a device that is owned by the user, and may be associated with the user, e.g., a pair of glasses, or a watch, or it may be a device that is handed out by the vendor, e.g., similarly to how 3D glasses are handed out at movie theaters. Augmented reality device 4100 may include an actual device, and may also include one or more additional devices that support augmented reality device 4100, whether physically located in proximity to the user (e.g., carried by the user in his or her pocket, or worn) or remote to the user.

In an embodiment, augmented reality device 4100 may include duplication module 4110. Duplication module 4110 may be configured to allow a user to pay for an item the user has taken a picture of, or placed in a cart, or grabbed, or otherwise indicated (e.g., looked at and pressed a button while wearing augmented reality glasses), and payment happens automatically, or with the touch of one (or a few) buttons, and the details are hidden from the user for both modality and option.

In an embodiment, augmented reality device 4100 may include a modality negotiation module 4210 may include a user payment modality preference retrieving module 4212 configured to retrieve a user payment modality preference. For example, if a user is sitting down in a crowded coffee shop, a user may be reluctant to get up to pay for a bagel, and risk losing her seat. In an embodiment, modality negotiation module 4210 may include vendor modality retrieving module 4214, which may retrieve a vendor payment modality similarly to one of the previously described techniques. For example, the device may detect, or is told, that a store in which the user is located only supports barcode payment or shopping cart modalities, but the user doesn't want to, or is physically incapable of, wait/waiting in a checkout line or self-checkout station. In an embodiment, modality selecting module 4220 may select a modality to carry out the user's request to pay for the item without additional help or input form the user. For example, modality selecting module 4220 may include modality interfacing database module 4222 and modality interfacing database data retrieving module 4224. For example, in an embodiment, if insufficient data is found in the modality interfacing database 4222, then use external resources (Internet, Google, an intranet of data from the device manufacturer) to determine how to interface using a modality accepted by the vendor.

In an embodiment, once a modality is selected, and information about how to interface with that modality is attained, then modality interfacing module may interface using the vendor's preferred modality. For example, modality interfacing module 4230 may include, in an embodiment, for example, vendor modality duplication learning module 4232. For example, in the illustrated barcode modality example, the device may retrieve all or a portion of the store's barcode recognition database. It is noted that this retrieval may not involve the vendor, rather, in an embodiment, the device may retrieve this information from a third party that stores these databases, or from various manufacturers of items that the user has selected.

In an embodiment, vendor modality duplication implementing module 4234 may use the data gathered by vendor modality duplication learning module, and use it to implement the data, e.g., in the example, retrieving the barcode of the item the user wants to purchase, e.g., by using an image processing sensor of the device.

In an embodiment, modality interfacing module 4230 also may include vendor modality duplication interfacing module 4236, which may be configured to interact with the vendor. For example, in the illustrated example, the vendor may have a vendor barcode reading device 6000. Vendor barcode reading device 6000 may include a barcode reader 60002, an input/output (which may be as simple as an LED) 6004, a store back-end 6008, and data processing unit 6006 that processes the data read in by the barcode reader 6002. In an embodiment, vendor modality duplication interfacing module 4236 interacts with the data processing unit 6006 of the vendor barcode reading device 6000 to deliver the obtained barcode to the vendor, such that the vendor does not distinguish between the transmission and the usual use of the modality, scanning the barcode at the vendor barcode reading device 6000.

In an embodiment, modality interfacing module 4230 also may include a transaction completing module 4238, which completes the transaction and may inform the user.

In an embodiment, a vendor device and/or system 6100 may interact with the system as previously described. In an embodiment, vendor system 6100 may include a vendor payment channel set communicating module 2610. For example, vendor payment channel set communicating module 2610 may include vendor payment channel set broadcasting module 2612, which may be configured to broadcast information, e.g., using vendor payment option set broadcasting module 2612A and vendor payment modality set broadcasting module 2612B.

In an embodiment, vendor payment channel set communicating module may include one or more of vendor payment communication negotiation with user device module 2614, which may include vendor payment option communication negotiation with user device module 2614A and vendor payment modality communication negotiation with user device module 2614B, vendor payment channel set determining module 2616, and vendor payment channel set monitoring module 2618. In an embodiment, for example, an example vendor may have exemplary vendor payment modality set 2604EX, and exemplary vendor payment option set 2602EX, which have been previously described herein, and which are selected merely for exemplary purposes and are non-limiting.

In an embodiment, vendor device 6100 may include vendor mass payment with variable payment channels system 6200. For example, in various circumstances, a vendor may want to process payments from lots of users that use different modalities, e.g., in a movie theater, people may have items that they've purchased, or a set of people might be waiting in line for a new type of tablet device or video game. Vendor variable payment channels system 6200, in an embodiment, may be designed to facilitate all these people's different payment channels (modalities and options) and process them.

In an embodiment, vendor device 6100 may include vendor operation implementation module 2620, which describes how a vendor may implement a similar system to as described with respect to user device 120. For example, in an embodiment, vendor operation implementation module 2620 may include vendor detection of a potential transaction module 2622. Module 2622 may detect that a transaction is about to take place, which may be based on vendor equipment, or based on a change in conditions, e.g., a position of a user. For example, module 2622 may be triggered, for example, by a user walking up to a self-checkout window in a grocery store, and hitting “start” on the screen.

In an embodiment, module 2620 may include a vendor payment channel obtaining module 2624. Vendor payment channel obtaining module 2624 may include vendor payment option obtaining module 2624A and vendor payment modality obtaining module 2624B. Vendor payment option obtaining module and vendor payment modality obtaining module may work similarly to their counterpart modules in the user device, e.g., vendor payment channel obtaining module 2410, with the exception that the vendor payment channel set may be stored locally.

In an embodiment of the invention, module 2620 may include a user payment channel obtaining module 2626. User payment channel obtaining module 2626 may include user payment channel obtaining module 2626A and user payment modality obtaining module 2626B. Similarly to as above, user payment channel obtaining module 2626 may operate in a similar manner to user payment channel obtaining module 2240, except that because the user payment channel data will probably be remote to vendor device 6100, the techniques for obtaining payment channel data in module 2410 also may be used, as described herein.

In an embodiment of the invention, module 2620 may include a payment channel determining module 2628. Payment channel determining module may select one or more of a payment option and a payment modality, similarly to as described in module 2501. Also similarly to module 2501, external resources may be used, for example, as detailed in payment option interfacing module 2550 and payment modality interfacing module 2640.

In an embodiment of the invention, module 2620 may include transaction facilitating module using determined payment channel 2629, which may facilitate the transaction using the selected payment channel and payment modality, similarly to as described in module 4000.

In an embodiment of the invention, an application module 3500 may be implemented by a program or application designer. The application may reside at various levels within the device, e.g., the application may be part of the kernel, part of the firmware, part of the operating system, it may be a preinstalled program or an essential program, or an independent program. The application may be implemented as an API or through any other known means of implementing an application, including hardware, software, firmware, programmable hardware, and others.

In an embodiment, an application module 3500 may include or interface with potential transaction detecting module 3510. In an embodiment, potential transaction detecting module may perform example 3510A of detecting a transaction or a potential for a transaction. In an embodiment, module 3510 may include one or more of device interface monitoring/communicating module 3512, device information gathering module 3514, device social network monitoring module 3516, device third party data regarding potential transaction receiving module 3518, and application communication with vendor facilitating module 3519.

In an embodiment, an application module 3500 may include or interface with a user payment channel obtaining module 3520. In an embodiment, user payment channel obtaining module 3520 may obtain, e.g., generate, receive, retrieve, or otherwise acquire a user payment channel from one or more sources. In an embodiment, user payment channel obtaining module 3520 may obtain a user payment channel set, and select a user payment channel from that user payment channel set. In an embodiment, user payment channel obtaining module 3520A may include one or more of application obtaining from device module 3522, application obtaining from vendor module 3524, application obtaining from third party module 3526, and application inferring module 3528.

In an embodiment, an application module 3500 may include or interface with a vendor payment channel obtaining module 3530. For example, in an embodiment, user vendor payment channel obtaining module 3530 may include obtaining the vendor payment channel from one or more sources 3530A. In an embodiment, vendor payment channel obtaining module 3530 may obtain a vendor payment channel set, and select one or more of a vendor payment option and/or a vendor payment modality, e.g., a vendor payment channel, from the vendor payment channel set. In an embodiment, vendor payment channel obtaining module may include one or more of application obtaining from device using device I/O module 3532, application obtaining from vendor directly module 3534, application obtaining from third party module 3536, application inferring module 3538, and application receiving vendor information from developer module 3539.

In an embodiment, an application module 3500 may include or interface with a payment channel set union obtaining module 3540, which, in an embodiment, may determine a usable payment channel set 3540A. In an embodiment, the payment channel set union obtaining module 3540 may include one or more of set comparator module 3542 and comparator output analyzing module 3544. In an embodiment, payment channel set union obtaining module 3540 may include or interface with empty set processing module 3560 or selected payment option and modality obtained from union set 3550 (e.g., which may include weighted union set analyzing module 3552), depending on whether there is union between a user payment channel set and a vendor payment channel set. If there is no union between the user payment channel set and the vendor payment channel set, processing moves to one or more of payment option interfacing module 2550 and/or payment modality interfacing module 2640, which are described in more detail elsewhere.

In an embodiment, vendor variable payment channels system 6200 may include a device payment channel determining module 6210 configured to communicate with the device to determine a device's payment channel. In an embodiment, vendor variable payment channels system 6200 also may include pay now instruction transmitting module 6212, and device payment acceptance module 6214, used to interface with the device modality as previously described. It is noted that the process by which this is carried out, as previously described with respect to user device 120, may take place at the vendor, at the user device, or partially at each of the devices, or using a third party device. In an embodiment, this process is repeated for all of the devices that are detected by the vendor mass payment system 6200. It is noted that although system 6200 is called vendor mass payment system 6200, that is merely for illustrative purposes, and in an embodiment, system 6200 may be provided by a third party, e.g., a device manufacturer, that may put limits on what kinds of devices are eligible for the mass payment system (e.g., only Samsung-branded phones are eligible, or only phones communicating on a 4G LTE network are eligible).

In an embodiment of the invention, a device, e.g., device 6500, may be used as a device intermediary, as previously described, with respect to module 2670. For example, a person or entity may authorize their device to act as a payment intermediary for one or more stores (and could be context-dependent, e.g., the store the person is in), where the device uses one or more modalities accepted by the vendor, and the device agrees to act as a broker, in exchange for some sort of reimbursement, from the vendor, or user, or a third party, or positive publicity (e.g., a tweet sent out from a user's twitter account that acknowledges the device owner). In an embodiment, device 6500 may include a condition defined as acceptable for a device to act as an intermediary detecting module 6510. Module 6510 may perform calculations or receive instructions, e.g., from a user, or from a third party with limited agency over the device, that determine when device 6500 is allowed to act as an intermediary. For example, module 6510 may include determining one or more conditions that permit the device to act as an intermediary device for unrelated devices module 6512, which may determine a condition under which device 6500 will act as an intermediary. In an embodiment, module 6510 also may include a detecting one or more of the determined conditions that permit the device to act as an intermediary device for unrelated devices module 6514, which may detect, or be informed of, one or more acceptable conditions. An example of one or more conditions may be that a device is set to act as an intermediary to unrelated devices when the device is located at an upscale shopping mall. Another example may be that a device is set to act as an intermediary to unrelated devices when the device is located at a store that is part of a particular corporate chain. Another example may be that a device is set to act as an intermediary to unrelated devices when the device is located at a store that accepts a particular type of payments (e.g., Google Wallet).

In an embodiment of the invention, device 6500 may include availability as an intermediary informing module 6520, which communicates availability as an intermediary device to a variety of devices through one or more methods. In an embodiment, module 6520 may include one or more of Signal Broadcasting Module 6522 for broadcasting a signal indicating availability as an intermediary that can be picked up by the client device, Vendor Communication and/or Registration Module 6524 for contacting the vendor and registering the device as available to perform intermediary work, Listening for Devices Module 6526 for listening to communication involving one or more client devices and/or offering/soliciting as an intermediary, and Third Party Requestor Communication Module for receiving communication from a non-vendor third party (e.g., a service provider to the vendor or to the client) requesting assistance as an intermediary 6528.

In an embodiment of the invention, device 6500 may include Intermediary Acceptance Module 6530 which may accept to act as an intermediary for the client device. This module may include intermediary compensation and/or agreement terms negotiating module 6532 and/or client data collecting module 6534. In an embodiment of the invention, device 6500 may include Intermediary Performance Module 6540 for performing intermediary assistance in payment option and/or payment modality between client (user) and vendor.

Referring again to FIG. 1, a manufacturer marketplace may act as an intermediary, as described in step 2554. Such an intermediary may include developer marketplace 6600. For example, a store operated by the operating system manufacturer of the device (e.g., the Microsoft Xbox games store for a device running a Microsoft operating system, e.g., Windows Phone 8.0, receives a request to assist with a transaction, e.g., purchasing a coffee at a coffee shop. The marketplace may collect data regarding payment channels of the coffee shop and the client device that is attempting to purchase the coffee. The marketplace then may provide the payment to the vendor for a transaction, using a payment channel that the client device does not have access to, and then may use its own existing payment channel with the client device to recapture the cost of the transaction.

In an embodiment, marketplace 6600 may include Request for Payment Channel Assistance Receiving Module 6610. For example, an online shopping marketplace (e.g., a transaction facilitator, e.g., the Apple App Store, or Google Play Store) receives a request for assistance with one or more payment channels and/or payment modalities from the client device. IN an embodiment, marketplace 6600 may include payment channel data gathering module 6620, which may be configured to gather information about the payment channels used by the client and the vendor, either directly from one or more of the client and/or vendor, or from other devices in the area.

In an embodiment, marketplace 6600 may include a Payment Channel Vendor Payment Facilitating Module 6630 configured to assist in providing payment to the vendor, utilizing one or more tools at its disposal, including possibly third party devices not under the direct control of the vendor, portions of the client device, the vendor device, or other resources.

In an embodiment, marketplace 6600 may include a Payment Channel Client Reimbursement Facilitating Module 6640 configured to, if necessary, if the vendor used one or more payment channels not directly involving the client device, the marketplace uses its payment channels, e.g., which may be preexisting due to the client relationship with the marketplace to collect the cost of the transaction from the client device. In another embodiment, marketplace 6600 may include marketplace as identifier tool module 6635 configured to may work with the vendor to confirm or certify an identity of the client device, in order to facilitate the transaction (e.g., which may be credit or accounts-payable based), rather than actually carry out the transaction.

Referring again to FIG. 1, e.g., FIG. 1H, other alternatives may be incorporated into the system. Some exemplary examples of these alternatives may include a frequent shopper reward application module 2190 that ensures that a user's frequent shopper cards are available as an option, or are automatically applied, a device search engine interface 2350, which goes to a search engine to get instructions to figure out how to interface with a particular payment channel, e.g., option or modality. In an embodiment, the system may include a credit card rewards program maximize module 2130 that may be configured to determine which credit card of a set of credit cards of the user to apply as the payment option to maximize user rewards, which may be based on an efficiency algorithm or a user preference that has been entered into the device.

In an embodiment, the system may include a trusted device voucher module 2354A, which, in an embodiment, in trying to verify the identity of a user, the vendor asks a device it trusts, e.g., a device it authenticates through a different means, to verify that the user device is legitimate. For example, a user's brother might not want to authenticate, or be unable to authenticate, so the user authenticates to the store with the user's device. The store then asks the user to verify that the person is indeed the user's brother. It could be limited to preexisting relationships, or types of relationships, e.g., blood relationships, marriage relationships, and familial relationships, or could use contact list information, or social network information.

In an embodiment, the system may include friendly device search interface 2360 configured to search the area to determine whether there are any devices that share a characteristic with the user device that ire in the vicinity.

In an embodiment, the system may include a small business assistance module 2140 configured to figure out whether a user wants to use a corporate card or not, e.g., based on one or more of where the user is located, what store the user is located in, what the user is buying, who the user is with, and the like.

In an embodiment, the system may include a frequent shopper card guaranteed use module 2150 configured to ensure that a user's frequent shopper card number is engaged when the purchase is completed, so that the user gets the credit.

Referring now to FIG. 2, FIG. 2 illustrates an example environment 200 in which the methods, systems, circuitry, articles of manufacture, and computer program products and architecture, in accordance with various embodiments, may be implemented by one or more user devices 220. As shown in FIG. 2A, one or more user devices 220, intermediate devices 230, external devices 240, and vendor devices 250 may communicate via one or more communication networks 240. In an embodiment, intermediate device(s) 230 may include intermediate device “A” 232 and/or intermediate device “B” 234. In an embodiment, vendor device 280 may include a vendor transaction processing system 282, a vendor interface system 284, and may include a vendor payment channel set 204, which may include one or more of a vendor payment modality set 204A and a vendor payment option set 204B. These will be discussed in more detail herein with respect to specific examples.

In an embodiment, external device 240 may include one or more of device list 242, vendor list 244, device communication interface 246, and vendor communication interface 248. Device 240 is listed as “external” not because it is necessarily external in temporal location or function, because in an embodiment, it may not be, but because external device 240 is not under the control of vendor device 280, user device 220, or intermediate device(s) 230, although any or all of the foregoing may communicate with external device 240.

User device 220 may be any electronic device, portable or not, that may be operated by or associated with one or more users. User device 220 is shown as interacting with a user 105. As set forth above, user 105 may be a person, or a group of people, or another entity that mimics the operations of a user. In an embodiment, user 105 may be a computer or a computer-controlled device. User device 220 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), wearable electronics, e.g., watches, belts, earphones, or “smart” clothing, earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

In an embodiment, user device 220 may be associated with user 105, and vendor device 280 may be associated with vendor 106. In an embodiment, user 105 may want to acquire goods and/or services from vendor 106, in what will be referred to throughout this application as a “transaction.” It is noted that “transaction” does not necessarily limit to the payment for a good or service. The transaction may incorporate such things as the user selecting an item, or requesting more information about an item from the vendor

In an embodiment, user 105 and user device 220 may facilitate the transaction using a user payment channel. A user payment channel may include one or more of a user payment modality and a user payment option. A user payment modality may be a method by which the user compensates the vendor for the one or more goods and services. A user payment option may be a specific type or form of payment that the user attempts to compensate the vendor for the goods or services. Examples of user payment options and user payment modalities are found in FIG. 1.

In an embodiment, vendor 106 and vendor device 280 may facilitate the transaction using a vendor payment channel. A vendor payment channel may include one or more of a vendor payment modality and a vendor payment option. A vendor payment modality may be a method by which the vendor compensates the vendor for the one or more goods and services. A vendor payment option may be a specific type or form of payment that the vendor attempts to compensate the vendor for the goods or services. Examples of vendor payment options and vendor payment modalities are found in FIG. 1.

In an embodiment, the user may wish to use the user payment channel to complete the transaction, regardless of what the vendor payment channel is. In an embodiment, the user may desire to not know what the vendor payment channel is, only that the transaction can be completed without the user changing his user payment channel to match the vendor payment channel. In an embodiment, there may not be an overlap, or a complete overlap, between the user payment channel and the vendor payment channel. In such instances, device 220 may form a sort of agnostic payment system, where to the user, it appears that only user payment channels are used, and the vendor payment channels are interfaced transparently to the user 105.

Referring now to FIG. 2B, user device 220 may include an operating system 224 with a kernel 223. In this context, operating system 224 refers to any hardware, software, firmware, and combination thereof which is considered at the core or baseline of a device. For example, applications that interact directly with hardware may be considered to be part of an operating system. In an embodiment, operating system 224 may be an FPGA, printed circuit board, or other wired device. In an embodiment, operating system 224 may include one or more of Google's Android, Apple's iOS, Microsoft's Windows, various implementations of Linux, and the like. In an embodiment, operating system 224 may include a root menu for one or more televisions, stereo systems, media players, and the like. In an embodiment, operating system 224 may be a “home” or base screen of a device.

Referring again to FIG. 2B, in an embodiment, user device 220 may include a user interface 223. User interface 223 may include any hardware, software, firmware, and combination thereof that allow a user 105 to interact with a user device 220, and for the user device 220 to interact with a user 105. In an embodiment, user interface 223 may include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 2B, in an embodiment, personal device 220 may include a device memory 226. In an embodiment, device memory 226 may include memory, random access memory (“RAM”), read only memory (“ROM”), flash memory, hard drives, disk-based media, disc-based media, magnetic storage, optical storage, volatile memory, nonvolatile memory, and any combination thereof. In an embodiment, device memory 226 may be separated from the device, e.g., available on a different device on a network, or over the air. For example, in a networked system, there may be many user devices 220 whose device memory 226 is located at a central server that may be a few feet away or located across an ocean. In an embodiment, user device 220 may include a device memory 226. In an embodiment, memory 226 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In an embodiment, memory 226 may be located at a single network site. In an embodiment, memory 226 may be located at multiple network sites, including sites that are distant from each other.

Referring again to FIG. 2B, in an embodiment, user device 220 may include device interface component 228. In an embodiment, device interface component 228 includes any component that allows the device to interact with its environment. For example, in an embodiment, device interface component 228 includes one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like. In an embodiment, device interface component 228 also may include one or more user interface components, e.g., user interface 225 (e.g., although they are drawn separately, in an embodiment, user interface 122 is a type of device interface component 128), and in an embodiment including one or more user input receiving components and output presenting components.

Referring again to FIG. 2B, FIG. 2B shows a more detailed description of user device. In an embodiment, user device 220 may include a processor 222. Processor 222 may include one or more microprocessors, Central Processing Units (“CPU”), a Graphics Processing Units (“GPU”), Physics Processing Units, Digital Signal Processors, Network Processors, Floating Point Processors, and the like. In an embodiment, processor 222 may be a server. In an embodiment, processor 222 may be a distributed-core processor. Although processor 222 is as a single processor that is part of a single user device 220, processor 222 may be multiple processors distributed over one or many user devices 220, which may or may not be configured to operate together. Processor 222 is illustrated as being configured to execute computer readable instructions in order to execute one or more operations described above, and as illustrated in FIGS. 6, 7A-7B, 8A-8D, and 9A-9Q. In an embodiment, processor 222 is designed to be configured to operate as processing module 250, which may include one or more of potential transaction between user and client indicator acquiring module 252 vendor payment channel set including one or more of at least one vendor payment modality and at least one vendor payment option at least partial acquiring module 254, and application of a user payment channel to at least one vendor payment channel of the acquired vendor payment channel set to facilitate the potential transaction module 256.

Referring now to FIG. 3, FIG. 3 illustrates an exemplary implementation of the potential transaction between user and client indicator acquiring module 252. As illustrated in FIG. 3, the potential transaction between user and client indicator acquiring module may include one or more sub-logic modules in various alternative implementations and embodiments. For example, as shown in FIG. 3, e.g., FIG. 3A, in an embodiment, module 252 may include one or more of indicator of a client device interface interaction acquiring module 302 and one or more parameters indicating potential transaction between client and vendor indicator detecting module 308. In an embodiment, module 302 may include indicator of client device soft key related to the potential transaction interaction by client acquiring module 304. In an embodiment, module 304 may include indicator of client device soft key interaction by the client indicating initiation of the potential transaction acquiring module 306. In an embodiment, module 308 may include one or more of client-associated device at particular location detecting module 310 and client activity indicating potential transaction between client and vendor detecting module 314. In an embodiment, module 310 may include client-associated device at particular vendor-specified retail shop dressage location detecting module 312. In an embodiment, module 314 may include client activity of manipulating a particular item indicating potential purchase of the particular item detecting module 316.

Referring again to FIG. 3, e.g., FIG. 3B, in an embodiment, module 252 may include one or more of potential transaction between client and vendor indicator acquiring from the vendor module 318, potential transaction between client and vendor indicator acquiring from a vendor-approved third party module 322, mechanically-inferred intent to carry out potential transaction between client and vendor indicator acquiring module 324, and event indicating intent of one or more of client and vendor to carry out potential transaction observing module 326. In an embodiment, module 318 may include commencement of transaction between client and vendor indicator acquiring from the vendor module 320.

Referring now to FIG. 4, FIG. 4 illustrates an exemplary implementation of vendor payment channel set including one or more of at least one vendor payment modality and at least one vendor payment option at least partial acquiring module 254. As illustrated in FIG. 4, the vendor payment channel set including one or more of at least one vendor payment modality and at least one vendor payment option at least partial acquiring module 254 may include one or more sub-logic modules in various alternative implementations and embodiments. For example, as shown in FIG. 4 (e.g., FIG. 4A), in an embodiment, module 254 may include one or more of vendor payment channel set including a first payment channel set and a second payment channel set having one or more of at least one vendor payment modality and at least one vendor payment option at least partial acquiring module 402 and particular vendor payment channel set including one or more of at least one vendor payment modality and at least one vendor payment option at least partial acquiring module 404. In an embodiment, module 404 may include particular vendor payment channel set including one or more operations of the client at least partially compensating the vendor for the potential transaction partial acquiring module 406. In an embodiment, module 406 may include particular vendor payment channel set including one or more operations of the client at least partially compensating the vendor for the potential transaction including various credit card operations partial acquiring module 408.

Referring again to FIG. 4, e.g., FIG. 4B, as described above, in an embodiment, module 254 may include one or more of particular vendor payment channel set including one or more of at least one vendor payment modality at least partial acquiring module 410 and vendor payment channel set including one vendor payment channel having a vendor payment option at least partial acquiring module 418. In an embodiment, module 410 may include particular vendor payment channel set including one or more of at least one vendor payment modality describing a manner of facilitating reception of compensation by the vendor at least partial acquiring module 412. In an embodiment, module 412 may include one or more of particular vendor payment channel set including one or more of at least one vendor payment modality describing a manner of facilitating reception of compensation by the vendor via a particular type of credit card modality at least partial acquiring module 414 and particular vendor payment channel set including one or more of at least one vendor payment modality describing a manner of facilitating reception of compensation by the vendor via a particular type of modality at least partial acquiring module 416.

Referring again to FIG. 4, e.g., FIG. 4C, in an embodiment, module 254 may include one or more of vendor payment channel set including one vendor payment channel having a vendor payment modality at least partial acquiring module 420 and vendor payment channel set including one or more vendor payment channels at least partial receiving module 422. In an embodiment, module 422 may include one or more of vendor payment channel set including one or more vendor payment channels at least partial receiving from the vendor module 424 and vendor payment channel set including one or more vendor payment channels at least partial receiving from a payment channel distributor module 426. In an embodiment, module 426 may include one or more of vendor payment channel set including one or more vendor payment channels at least partial receiving from a payment channel distributor related to the vendor module 428 and vendor payment channel set including one or more vendor payment channels at least partial receiving from a payment channel distributor related to the client module 430.

Referring again to FIG. 4, e.g., FIG. 4D, in an embodiment, module 254 may include vendor payment channel set including one or more vendor payment channels at least partial generating module 432. In an embodiment, module 432 may include vendor payment channel set including one or more vendor payment channels generating data at least partially from acquired data regarding the vendor module 434. In an embodiment, module 434 may include one or more of vendor payment channel set including one or more vendor payment channels generating data at least partially from data regarding the vendor acquired from an external resource module 436.

Referring now to FIG. 5, FIG. 5 illustrates an exemplary implementation of application of a user payment channel to at least one vendor payment channel of the acquired vendor payment channel set to facilitate the potential transaction module 256. As illustrated in FIG. 5, the application of a user payment channel to at least one vendor payment channel of the acquired vendor payment channel set to facilitate the potential transaction module 256 may include one or more sub-logic modules in various alternative implementations and embodiments. For example, as shown in FIG. 5, e.g., FIG. 5A, in an embodiment, module 256 may include one or more of application of a client payment channel to at least one vendor payment channel of the acquired vendor payment channel set to facilitate the client carrying out the transaction with the vendor module 502, application of a client payment channel to at least one vendor payment channel of the acquired vendor payment channel set to facilitate the potential transaction without client specific knowledge of the at least one vendor payment channel module 504, and application of a client payment channel to at least one vendor payment channel of the acquired vendor payment channel set to facilitate the potential transaction without client interaction during the potential transaction module 506.

Referring again to FIG. 5, e.g., FIG. 5B, in an embodiment, module 256 may include one or more of client payment channel set at least partly based on one or more user device attributes generating module 508 and application of a client payment channel taken from the client payment channel set to at least one vendor payment channel of the acquired vendor payment channel set to facilitate the potential transaction module 510. In an embodiment, module 508 may include one or more of client payment channel set at least partly based on one or more user device attributes and at least partly based on vendor payment channel set generating module 512, client payment channel set having a single client payment channel at least partly based on one or more user device attributes generating module 514, client payment channel set at least partly based on one or more user device configurations generating module 516 (e.g., which, in an embodiment, may include client payment channel set at least partly based on one or more client device configurations previously set by a client generating module 518), one or more client payment channel preference designations retrieving module 520 (e.g., which, in an embodiment, may include one or more client payment channel preference designations including one or more of at least one client payment modality preference designation and at least one client payment option preference designation retrieving module 524), and client payment channel set generating at least partly based on the retrieved one or more client payment channel preference designations retrieving module 522.

Referring again to FIG. 5, e.g., FIG. 5C, in an embodiment, module 256 may include one or more of module 508, module 520, and module 524, as previously described. In an embodiment, module 524 may include one or more of one or more client payment channel ordered ranking designations retrieving module 526 and one or more client payment modality preferences including a first credit card modality preference and a second credit card modality preference that are rank-ordered retrieving module 532. In an embodiment, module 526 may include one or more client payment modality ordered ranking and client payment option ordered ranking designations retrieving module 528. In an embodiment, module 528 may include one or more client payment modality ordered ranking and client payment option related ordered ranking designations retrieving module 530.

Referring again to FIG. 5, e.g., FIG. 5D, in an embodiment, module 256 may include module 508, as previously described. In an embodiment, module 508 may include one or more of client payment channel set at least partly based on one or more user device attributes set by device manufacturer generating module 534, client payment channel set at least partly based on one or more user device attributes set by application generating module 536, and client payment channel set at least partly based on one or more user device data processing capabilities module 538. In an embodiment, module 538 may include one or more of client payment channel set at least partly based on user device bar code data processing capability module 540 and client payment channel set at least partly based on biometric data processing capability module 542.

Referring again to FIG. 5, e.g., FIG. 5E, in an embodiment, module 256 may include module 508, as previously described. In an embodiment, module 508 may include client payment channel set at least partly based on one or more data access authorization capabilities module 544. In an embodiment, module 544 may include one or more of client payment channel set at least partly based on data access to one or more proprietary vendor translation codes module 546 and client payment channel set at least partly based on data access to one or more client-related credit card databases codes module 548.

Referring again to FIG. 5, e.g., FIG. 5F, in an embodiment, module 256 may include application of a client payment channel present in the vendor payment channel set to at least one vendor payment channel of the acquired vendor payment channel set to facilitate the potential transaction module 550. In an embodiment, module 550 may include one or more of client payment channel set acquisition module 552 and application of a client payment channel present in the vendor payment channel set and present in the acquired client payment channel set to at least one vendor payment channel of the acquired vendor payment channel set to facilitate the potential transaction module 554. In an embodiment, module 552 may include one or more of client payment channel set including at least one of a client payment option set and a client payment modality set acquisition module 556, client payment channel set receiving from client device module 558, client payment channel set receiving from client-associated device module 560, and client payment channel set receiving from storage device for one or more of at least one user payment option and at least one user payment modality module 562.

Referring again to FIG. 5, e.g., FIG. 5G, in an embodiment, module 256 may include one or more of client payment channel generating module 564 and application of generated client payment channel to at least one vendor payment channel of the acquired vendor payment channel set to facilitate the potential transaction module 566. In an embodiment, module 564 may include one or more of client payment channel generating based on client device data module 568 and client payment channel set generating based on data acquired from entities associated with one or more client payment modalities or one or more client payment options module 570.

Referring again to FIG. 5, e.g., FIG. 5H, in an embodiment, module 256 may include application of a client payment channel present in the vendor payment channel set to at least one vendor payment channel of the acquired vendor payment channel set to facilitate the potential transaction module 572. In an embodiment, module 572 may include selection of the client payment channel present in the vendor payment channel set to facilitate the potential transaction module 574. In an embodiment, module 574 may include selection of the client payment channel present in the vendor payment channel set based on at least one vendor payment channel preference to facilitate the potential transaction module 576. In an embodiment, module 576 may include one or more of selection of the client payment channel present in the vendor payment channel set at least partly based on at least one vendor-based payment channel ranking to facilitate the potential transaction module 578, first portion of vendor payment channel set including a first vendor payment channel receiving module 580, second portion of vendor payment channel set including a second vendor payment channel receiving module 582, selecting vendor payment channel from second portion of vendor payment channel set module 584 (e.g., which, in an embodiment, may include selecting vendor payment channel from second portion of vendor payment channel set after rejecting one or more vendor payment channels from the first vendor payment channel set module 586), selection of a client payment modality present in the vendor payment channel set based on at least one vendor payment modality preference to facilitate the potential transaction module 588, and selection of a client payment option present in the vendor payment channel set based on at least one vendor payment option preference to facilitate the potential transaction module 590.

Referring again to FIG. 5, e.g., FIG. 5I, in an embodiment, module 256 may include application of a client payment channel absent in the vendor payment channel set to at least one vendor payment channel of the acquired vendor payment channel set to facilitate the potential transaction module 592. In an embodiment, module 592 may include one or more of application of a client payment channel absent in the vendor payment channel set to a vendor payment channel of the acquired vendor payment channel set that is similar to the client payment channel, to facilitate the potential transaction module 594, facilitating a particular portion of the potential transaction using the client payment channel module 596, facilitating a further portion of the potential transaction using the client payment channel module 598, conversion of the client payment cannel into the vendor payment channel to facilitate the potential transaction module 501, facilitating a particular portion of the potential transaction using a client payment option of the client payment channel module 503, and at least a portion of data received from the facilitated particular portion of the potential transaction conversion into vendor-acceptable data configured to be used by a vendor payment option of the vendor payment channel set module 505. In an embodiment, module 505 may include first credit card data received from the facilitated particular portion of the potential transaction conversion into vendor-acceptable second credit card data configured to be used by a vendor payment option of the vendor payment channel set module 507. In an embodiment, module 507 may include first credit card data received from the facilitated particular portion of the potential transaction conversion into vendor-acceptable second credit card data configured to be used by a vendor payment option of the vendor payment channel set at least partially using data from a second credit card provider module 509.

Referring again to FIG. 5, e.g., FIG. 5J, in an embodiment, module 256 may include one or more of facilitating a particular portion of the potential transaction using a client payment modality of the client payment channel module 511 and at least a portion of data received from the facilitated particular portion of the potential transaction conversion into vendor-acceptable data configured to be used by a vendor payment modality of the vendor payment channel set module 513. In an embodiment, module 513 may include one or more of external resource configured to use the vendor payment modality communicating module 515 and facilitating the further portion of the potential transaction with the vendor payment modality at least partly using the external resource as an intermediary module 517. In an embodiment, module 515 may include one or more of one or more external resource identifiers obtaining module 519 and external resource having an obtained external resource identifier communicating module 521. In an embodiment, module 519 may include one or more of one or more registered external resource identifiers obtaining from a resource manager module 523, one or more external resource identifiers obtaining from a vendor-associated resource manager module 525, one or more external resource identifiers obtaining from a user-associated resource manager module 527, and one or more external resource identifiers having particular property obtaining module 529. In an embodiment, module 529 may include one or more external resource identifiers having at least one external resource payment channel present in the vendor payment channel set module 531.

Referring again to FIG. 5, e.g., FIG. 5K, in an embodiment, module 256 may include module 511, module 513, module 515, module 519, and module 529, as previously described. In an embodiment, module 256 may include one or more of one or more external resource identifiers having at least one external resource payment channel present in the vendor payment channel set and at least one external resource payment channel present in a user payment channel set module 533, one or more external resource identifiers related to a resource manager obtaining from the resource manager module 535, and one or more external resource identifiers having particular position obtaining module 537. In an embodiment, module 537 may include one or more external resource identifiers having particular position in proximity to one or more of a client device and a vendor dressage obtaining module 539.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 6 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIGS. 7-9 as well as the other operations to be described herein may be performed by at least one of a machine, an article of manufacture, or a composition of matter.

Referring now to FIG. 6, FIG. 6 shows operation 600, which may include operation 602 depicting acquiring an indication of one or more conditions related to a potential transaction between a vendor and a user. For example, FIG. 2, e.g., FIG. 2B, shows potential transaction between user and client indicator acquiring module 252 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) an indication (e.g., including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds), alone or in any combination, of one or more conditions (e.g., any measurable or observable state, whether static, dynamic, or otherwise, including spatial, temporal, physical, metaphysical, electronic, virtual, and otherwise) related to (e.g., has some affiliation with, regardless of how loosely or how inclusive the relationship is) a potential transaction (e.g., any portion of an exchange of goods and/or services for consideration) between a vendor (e.g., any entity that is providing one or more goods and/or services) and a user (e.g., any entity willing to provide compensation for the providing of one or more goods and/or services).

Referring again to FIG. 6, operation 600 may include operation 604 depicting acquiring a vendor payment channel set, said vendor payment channel set including one or more vendor payment channels, at least one of said one or more vendor payment channels including at least one of a vendor payment option and a vendor payment modality. For example, FIG. 2, e.g., FIG. 2B, shows vendor payment channel set including one or more of at least one vendor payment modality and at least one vendor payment option at least partial acquiring module 254 acquiring (e.g., obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) a vendor payment channel set (e.g., a set, which in some embodiments may include the empty set, of one or more of a vendor payment option (e.g., a form of compensation that the vendor may accept) and/or one or more of a vendor payment modality (e.g., a method of transmitting compensation from the user that the vendor may accept) including one or more vendor payment channels (e.g., one or more of a vendor payment channel and/or a vendor payment modality), at least one of said one or more vendor payment channels (e.g., one or more of a vendor payment channel and/or a vendor payment modality) including at least one of a vendor payment option (e.g., a form of compensation that the vendor may accept, e.g., credit card alpha, credit card beta, store credit card, fuel rewards card, bank gamma debit card, bank delta debit card, corporate credit card, PayPal account, frequent shopper rewards card, nonspecific gift certificate, vendor-specific gift certificate, instant credit approval mechanism, cash, casino chips, tokens, foreign currency, BitCoins, travelers check, bearer bonds, game system points, store credit) and a vendor payment modality (e.g., a method of transmitting compensation from the user that the vendor may accept, e.g., credit card verification with swipe only, credit card verification with personal identification number (“PIN”) entry, credit card verification with signature, credit card verification with physical card proximity using radio frequency identifiers (“RFID”), device tap using near field communication (“NFC”), device authentication via wireless network, device authentication via cellular network, indirect device authentication via a device manufacturer network, retinal scan, fingerprint scan, speech recognition, voice recognition, device proxy, password only, trusted device voucher, quick response code, one-dimensional bar code, color barcode, card-embedded microchip, virtual currency transaction, electronic funds transfer, three-dimensional object verification, check authorization, cash anti-counterfeiting procedure).

Referring again to FIG. 6, operation 600 may include operation 606 depicting adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set. For example. FIG. 2, e.g., FIG. 2B, shows application of a user payment channel to at least one vendor payment channel of the acquired vendor payment channel set to facilitate the potential transaction module 256 adapting (e.g., taking one or more actions, alone or with the assistance of an external resource, that are intended to assist in facilitating at least a portion of the ultimate transaction between a user and a vendor) at least one user payment channel (e.g., one or more of a user payment option (e.g., a form of compensation that the user may be capable of using) and a user payment modality (e.g., a method of transmitting compensation that the user may be capable of carrying out, e.g., at least partly via a user device) for use with a vendor payment channel (e.g., one or more of a vendor payment channel and/or a vendor payment modality) to facilitate (e.g., attempting at least one action intended to assist in the carrying out of) at least a portion of the potential transaction (e.g., any portion of an exchange of goods and/or services for consideration), wherein the adapting at least one user payment channel (e.g., one or more of a user payment option (e.g., a form of compensation that the user may be capable of using) and a user payment modality (e.g., a method of transmitting compensation that the user may be capable of carrying out, e.g., at least partly via a user device) includes one or more of selecting a user payment channel that is present (e.g., at least a portion of the user payment channel is also present in a same or similar format) in the vendor payment channel set and interfacing (e.g., taking one or more steps to allow one or more payment options and/or payment modalities that are not the same to work together seamlessly) a user payment channel (e.g., one or more of a user payment option (e.g., a form of compensation that the user may be capable of using) and a user payment modality (e.g., a method of transmitting compensation that the user may be capable of carrying out, e.g., at least partly via a user device) that is absent (e.g., not present) in the vendor payment channel set.

FIGS. 7A-7E depict various implementations of operation 602, depicting acquiring an indication of one or more conditions related to a potential transaction between a vendor and a user according to embodiments. Referring now to FIG. 6A, operation 602 may include operation 702 depicting receiving an indication that a user has interacted with an interface of a personal device, said interaction related to the potential transaction between the vendor and the user. For example, FIG. 3, e.g., FIG. 3A shows indicator of personal device interface interaction acquiring module 302 receiving an indication (e.g., an electronic signal) that a user has interacted (e.g., pushed a button of, turned on, spoken to, received data from, or otherwise caused a sensor or component, hardware or software of the device, to change) with an interface of a personal device.

It is noted that “indicator” and “indication” can refer to many different things, including any of electronic signals (e.g., pulses between two components), human-understandable signals (e.g., information being displayed on a screen, or a lighting of a light, or a playing of a sound), and non-machine related signals (e.g., two people talking, a change in ambient temperature, the occurrence of an event, whether large scale (e.g., earthquake) or small-scale (e.g., the time becomes 4:09 p.m. and 32 seconds), alone or in any combination.

Referring again to FIG. 7A, operation 702 may include operation 704 depicting receiving an indication that the user has pressed a button of a smartphone, said indication related to the potential transaction between the vendor and the user. For example, FIG. 3, e.g., FIG. 3A, shows indicator of personal device soft key related to the potential transaction interaction by client acquiring module 304 receiving an indication (e.g., a signal from an input/output controller of a device, e.g., device interface component 228 of FIG. 2B) that the user has pressed a button of a smartphone (e.g., an Apple iPhone), said indication (e.g., the indication is an indication that the user pressed a “buy” button that was displayed on the screen of the device) related to the potential transaction (e.g., paying for a coffee that was ordered) between the vendor (e.g., a coffee shop, e.g., Starbucks) and the user (e.g., a person that ordered a coffee drink at a coffee shop).

Referring again to FIG. 7A, operation 704 may include operation 706 depicting receiving an indication that the user has pressed the button of the smartphone, said received indication that the user has pressed the button of the smartphone corresponding to a user initiating a potential transaction. For example, FIG. 3, e.g., FIG. 3A, shows indicator of personal device soft key interaction by the client indicating initiation of the potential transaction acquiring module 306 receiving an indication (e.g., a signal received at a receiving device from a smart watch worn on the user's hand has detected a particular occurrence (e.g., a particular hand motion of pressing a button on a smartphone), said received indication that the user has pressed the button of the smartphone (e.g., a Samsung android operating system-based smartphone) corresponding to a user initiating a potential transaction (e.g., a user buying a CD at a music store).

Referring again to FIG. 7A, operation 602 may include operation 708 depicting detecting one or more conditions related to the potential transaction between the vendor and the user. For example, FIG. 3, e.g., FIG. 3A, shows one or more parameters indicating potential transaction between client and vendor indicator detecting module 308 detecting (e.g., one or more of observing, noticing, recording, listening, acquiring, obtaining, receiving, calculating, selecting from a list or other data structure, receiving, retrieving, or receiving information regarding, performing calculations to find out, retrieving data that indicates, receiving notification, or receiving information that leads to an inference, for example) one or more conditions (e.g., a user has placed an item at a grocery store in the user's shopping cart) related to the potential transaction (e.g., in this instance, the potential transaction is merely to receive the total price of the item (which may be dynamic, e.g., it might depend on total weight of the item, or on its color if it is a fruit or a vegetable)) between the vendor (e.g., a supermarket) and the user (e.g., a shopper at a supermarket).

Referring again to FIG. 7A, operation 708 may include operation 710 depicting detecting that a device associated with the user is at a particular location. For example, FIG. 3, e.g., FIG. 3A, shows client-associated device at particular location detecting module 310 detecting that a device (e.g., an augmented reality projection device, e.g., glasses or a headband) associated (e.g., worn by) with the user (e.g., a person watching a live performance at an art show that has elected for AR augmentation for the show and will be charged for it) is at a particular location (e.g., in a particular seat at the performance).

It is noted that, in the foregoing example, the word “associated” means “worn by,” but the word is not limited to that type of definition. Associated does not require physical proximity. A device could be associated with a user if the user purchased that device, or stores information on that device, or has ever logged in and identified herself to that device. In addition, a device may be associated with a user if the user holds the device, carries the device, operates the device, or is assigned the device.

Referring again to FIG. 7A, operation 710 may include operation 712 depicting detecting that the device associated with the user is within a particular location defined by the vendor. For example, FIG. 3, e.g., FIG. 3A, shows client-associated device at particular vendor-specified retail shop dressage location detecting module 312 detecting that the device (e.g., a smartphone) associated with the user (e.g., a customer at a taco stand) is within a particular location (e.g., within 20 feet of the taco stand) defined by the vendor (e.g., the taco stand determines how may feet trigger detection, e.g., in an example, it is twenty feet).

Referring again to FIG. 7A, operation 708 may include operation 714 depicting detecting that the user carried out one or more particular actions. For example, FIG. 3, e.g., FIG. 3A, shows client activity indicating potential transaction between client and vendor detecting module 314 detecting (e.g., for a device that can receive speech communication, hearing user speech) that the user (e.g., a customer in an electronics store, e.g., Best Buy) carried out one or more particular actions (e.g., a user picked up an item that the user is considering purchasing and spoke the words “price check”).

Referring again to FIG. 7A, operation 714 may include operation 716 depicting detecting that the user placed an item intended for purchase into a shopping cart. For example, FIG. 3, e.g., FIG. 3A, shows client activity of manipulating a particular item indicating potential purchase of the particular item detecting module 316 detecting (e.g., through visual detection systems) that the user (e.g., a grocery store shopper) placed an item (e.g., a raw sirloin steak) intended for purchase into a shopping cart (e.g., in an example, this is a physical shopping cart, but in another embodiment, it could be a virtual shopping cart, e.g., through a series of mouse clicks, a user caused a digital audio music album to be placed in a virtual shopping cart, e.g., a cart in an online shopping store, e.g., Amazon.com).

Referring now to FIG. 7B, operation 602 may include operation 718 depicting receiving, from the vendor, an indication of a potential transaction between the vendor and the user. For example, FIG. 3, e.g., FIG. 3B, shows potential transaction between client and vendor indicator acquiring from the vendor module 318 receiving, from the vendor (e.g., from the shop entity, e.g., from dedicated hardware in the coffee shop), an indication (e.g., the vendor hardware has detected that the user has placed an order, through speaking or through pushing a button) of a potential transaction (e.g., the purchasing of a coffee drink) between the vendor (e.g., the coffee shop entity) and the user (e.g., the person purchasing the coffee drink).

Referring again to FIG. 7B, operation 718 may include operation 720 depicting receiving, from the vendor, a signal indicating a start of a transaction between the vendor and the user. For example, FIG. 3, e.g., FIG. 3B, shows commencement of transaction between client and vendor indicator acquiring from the vendor module 320 receiving, from the vendor (e.g., an ice cream shop dispenser), a signal (e.g., a transmission from third party hardware that is licensed by the vendor) indicating a start of a transaction (e.g., the user has pushed the “pay automatically using my credit card button” on the third party hardware licensed by the vendor) between the vendor (ice cream shop) and the user (e.g., the ice cream purchaser). As is made clear by this example, the “from the vendor” of this and other claims may mean directly from the vendor entity, or from third party or other entities that are working with the vendor, either as directly licensed equipment, or remote entity that has entered into a contract to provide services with the vendor, and the like).

Referring again to FIG. 7B, operation 602 may include operation 722 depicting receiving, from a third party contracting from the vendor, an indication of a potential transaction between the vendor and the user. For example, FIG. 3, e.g., FIG. 3B, shows potential transaction between client and vendor indicator acquiring from a vendor-approved third party module 322 receiving, from a third party (e.g., Apple's payment network) contracting from the vendor (e.g., a taco stand has a relationship with Apple computers), an indication of a potential transaction (e.g., the purchase of a chimichanga) between the vendor (e.g., the taco stand) and the user (e.g., the purchaser of the chimichanga).

Referring again to FIG. 7B, operation 602 may include operation 724 depicting acquiring an indication that one or more of the user and the vendor intend to carry out the potential transaction. For example, FIG. 3, e.g., FIG. 3B, shows mechanically-inferred intent to carry out potential transaction between client and vendor indicator acquiring module 324 acquiring an indication (e.g., a signal from a device carried by the user, e.g., a smartphone, or a smartwatch, or smart sneakers) that one or more of the user (e.g., a person running a race has entered the “pay for a drink” line at the rest stop and does not have to stop for authorization) and the vendor intend (e.g., the user has indicated her intent by running into the “pay for a drink” line which is detected by the smart sneakers, either through running over a particular RFID-enabled plate, or through GPS positioning, or visual aids) to carry out the potential transaction (e.g., pay for a Gatorade-branded sports recovery drink halfway through a half-marathon).

Referring again to FIG. 7B, operation 602 may include operation 726 depicting acquiring an indication of one or more events that may indicate an intention of one or more of the user and the vendor to carry out the potential transaction. For example, FIG. 3, e.g., FIG. 3B, shows event indicating intent of one or more of client and vendor to carry out potential transaction observing module 326 acquiring an indication of one or more events (e.g., with smart clothing, the user has put on the smart clothing and wants to wear it out of the store) that may indicate an intention (e.g., putting on the clothing may indicate an intention, or the user may just be trying out the smart clothing) of one or more of the user and the vendor (e.g., the clothing store) to carry out the potential transaction (e.g., buying the smart clothing). In the context of the previous example, “smart clothing” is clothing that includes one or more processors, whether local or remote, which provide some information about the clothing, e.g., clothing that can tell when a safety pin has been removed, or when it has been put on, or when it has been taken out of the store.

FIGS. 8A-8C depict various implementations of operation 604, depicting acquiring a vendor payment channel set, said vendor payment channel set including one or more vendor payment channels, at least one of said one or more vendor payment channels including at least one of a vendor payment option and a vendor payment modality, according to embodiments. Referring now to FIG. 8A, operation 604 may include operation 802 depicting acquiring a vendor payment channel set, said vendor payment channel set including a first vendor payment channel and a second vendor payment channel, said first vendor payment channel set including a vendor payment option and a vendor payment modality. For example, FIG. 4, e.g., FIG. 4A, shows vendor payment channel set including a first payment channel set and a second payment channel set having one or more of at least one vendor payment modality and at least one vendor payment option at least partial acquiring module 402 acquiring a vendor payment channel set (e.g., two vendor payment options (e.g., credit card alpha (e.g., Visa credit card) and credit card beta (e.g., MasterCard credit card)) and three payment modalities (e.g., credit card verification with swipe only, credit card verification with physical card proximity using radio frequency identifiers (“RFID”), and device tap using near field communication (“NFC”))) including a first vendor payment channel (e.g., one vendor payment option and one vendor payment channel, e.g., credit card alpha and credit card verification with swipe only) and a second vendor payment channel (e.g., a vendor payment channel containing only a vendor payment modality (e.g., device tap using NFC), said first vendor payment channel set including a vendor payment option (e.g., credit card alpha, e.g., Visa credit card) and a vendor payment modality (e.g., credit card verification using swipe only). As illustrated by the foregoing example, a vendor payment channel set may have zero or more vendor payment channels. Each vendor payment channel may have one or more vendor payment options or one or more vendor payment modalities, which may or may not be related, and of which there may or may not be the same number.

Referring again to FIG. 8A, operation 604 may include operation 804 depicting acquiring a vendor payment channel set, said vendor payment channel set including a particular vendor payment channel set, said particular vendor payment channel set including a vendor payment option set. For example, FIG. 4, e.g., FIG. 4A, shows particular vendor payment channel set including one or more of at least one vendor payment modality and at least one vendor payment option at least partial acquiring module 404 acquiring a vendor payment channel set (e.g., two vendor payment options (e.g., store credit card, fuel rewards card) and two vendor payment modalities, (e.g., credit card verification with signature and color barcode)), said vendor payment channel set including a particular vendor payment channel set (e.g., two vendor payment options (e.g., store credit card, fuel rewards card) and two vendor payment modalities, (e.g., credit card verification with signature and color barcode)), said particular vendor payment channel set including a vendor payment option set (e.g., store credit card, fuel rewards card).

Referring again to FIG. 8A, operation 804 may include operation 806 depicting acquiring a vendor payment channel set, said vendor payment channel set including a particular vendor payment channel set, said particular vendor payment channel set including a vendor payment option set, said vendor payment option set including one or more operations of payment by the user. For example, FIG. 4, e.g., FIG. 4A, shows particular vendor payment channel set including one or more methods of the client at least partially compensating the vendor for the potential transaction partial acquiring module 406 acquiring a vendor payment channel set (e.g., a vendor payment option set (e.g., corporate credit card, PayPal account, frequent shopper rewards card) and a vendor payment modality set (e.g., speech recognition, voice recognition, device proxy, password only, trusted device voucher, quick response code)), said vendor payment channel set including a particular vendor payment channel set (e.g., a vendor payment option set (e.g., corporate credit card, PayPal account, frequent shopper rewards card) and a vendor payment modality set (e.g., speech recognition, voice recognition, device proxy, password only, trusted device voucher, quick response code)), said particular vendor payment channel set including a vendor payment option set (e.g., corporate credit card, PayPal account, frequent shopper rewards card), said vendor payment option set including one or more operations of payment (e.g., ways to pay) by the user (e.g., the purchaser of goods and/or services in this transaction).

Referring again to FIG. 8A, operation 806 may include operation 808 depicting acquiring the vendor payment channel set, said vendor payment channel set including a particular vendor payment channel set, said particular vendor payment channel set including the vendor payment option set, said vendor payment option set including one or more of a credit card transaction, a cash transaction, a check-writing transaction, and a debit card transaction requiring a personal identification number entry. For example, FIG. 4, e.g., FIG. 4A, shows particular vendor payment channel set including one or more operations of the client at least partially compensating the vendor for the potential transaction including various credit card operations partial acquiring module 408 acquiring the vendor payment channel set, said vendor payment channel set including a particular vendor payment channel set, said particular vendor payment channel set including the vendor payment option set, said vendor payment option set including one or more of a credit card transaction, a cash transaction, a check-writing transaction, and a debit card transaction requiring a personal identification number entry.

Referring now to FIG. 8B, operation 604 may include operation 810 depicting acquiring the vendor payment channel set, said vendor payment channel set including a particular vendor payment channel set, said particular vendor payment channel set including a particular vendor payment modality set. For example, FIG. 4, e.g., FIG. 4B, shows particular vendor payment channel set including one or more of at least one vendor payment modality at least partial acquiring module 410 acquiring the vendor payment channel set (e.g., two vendor payment options (e.g., frequent shopper rewards card, nonspecific gift certificate) and two vendor payment modalities (e.g., card-embedded microchip, virtual currency transaction), said vendor payment channel set including a particular vendor payment channel set (e.g., one vendor payment option (e.g., the frequent shopper rewards card) and one vendor payment modality (e.g., virtual currency transaction), said particular vendor payment channel set including a particular vendor payment modality set (e.g., a virtual currency transaction).

Referring again to FIG. 8B, operation 810 may include operation 812 depicting acquiring the vendor payment channel set, said vendor payment channel set including a particular vendor payment channel set, said particular vendor payment channel set including one or more manners of transmitting payment from the user to the vendor. For example, FIG. 4, e.g., FIG. 4B, shows particular vendor payment channel set including one or more of at least one vendor payment modality describing a manner of facilitating reception of compensation by the vendor at least partial acquiring module 412 acquiring the vendor payment channel set (e.g., twelve vendor payment options and fifteen vendor payment modality), said vendor payment channel set including a particular vendor payment channel set (e.g., foreign currency, BitCoins, travelers check, bearer bonds, and quick response code, one-dimensional bar code, color barcode, card-embedded microchip, virtual currency transaction), said particular vendor payment channel set including one or more manners of transmitting payment from the user to the vendor.

Referring again to FIG. 8B, operation 812 may include operation 814 depicting acquiring the vendor payment channel set, said vendor payment channel set including the particular vendor payment channel set, said particular vendor payment channel set including the particular vendor payment modality set, said particular vendor payment modality set including one or more of a credit card swipe, a credit card with a personal identification number entry, a credit card swipe with signature, and a credit card swipe with proximity. For example, FIG. 4, e.g., FIG. 4B, shows particular vendor payment channel set including one or more of at least one vendor payment modality describing a manner of facilitating reception of compensation by the vendor via a particular type of credit card modality at least partial acquiring module 414 acquiring the vendor payment channel set, said vendor payment channel set including the particular vendor payment channel set, said particular vendor payment channel set including the particular vendor payment modality set, said particular vendor payment modality set including one or more of a credit card swipe, a credit card with a personal identification number entry, a credit card swipe with signature, and a credit card swipe with proximity.

Referring again to FIG. 8B, operation 812 may include operation 816 depicting acquiring the vendor payment channel set, said vendor payment channel set including the particular vendor payment channel set, said particular vendor payment channel set including the particular vendor payment modality set, said particular vendor payment modality set including one or more of a device tap using near-field communications, a device authentication over a wireless network, a biometric retinal identification, a speech recognition, a card-embedded microchip, a two-dimensional barcode scan, and a virtual currency transmitter. For example, FIG. 4, e.g., FIG. 4B, shows particular vendor payment channel set including one or more of at least one vendor payment modality describing a manner of facilitating reception of compensation by the vendor via a particular type of modality at least partial acquiring module 416 acquiring the vendor payment channel set, said vendor payment channel set including the particular vendor payment channel set, said particular vendor payment channel set including the particular vendor payment modality set, said particular vendor payment modality set including one or more of a device tap using near-field communications, a device authentication over a wireless network, a biometric retinal identification, a speech recognition, a card-embedded microchip, a two-dimensional barcode scan, and a virtual currency transmitter.

Referring again to FIG. 8B, operation 604 may include operation 818 depicting acquiring a vendor payment channel set including one vendor payment channel, said vendor payment channel including a vendor payment option. For example, FIG. 4, e.g., FIG. 4B, shows vendor payment channel set including one vendor payment channel having a vendor payment option at least partial acquiring module 818 acquiring a vendor payment channel set including one vendor payment channel (e.g., one vendor payment option and one vendor payment modality), said vendor payment channel including a vendor payment option (e.g., Visa-branded credit cards).

Referring now to FIG. 8C, operation 604 may include operation 820 depicting acquiring a vendor payment channel set including one vendor payment channel, said vendor payment channel including a vendor payment modality. For example, FIG. 4, e.g., FIG. 4C, shows vendor payment channel set including one vendor payment channel having a vendor payment modality at least partial acquiring module 420 acquiring a vendor payment channel set including one vendor payment channel (e.g., one vendor payment modality only), said vendor payment channel including a vendor payment modality (e.g., credit card verification with electronic signature checking through using computer vision to analyze a user's signature and compare it to a signature on file with the credit card company).

Referring again to FIG. 8C, operation 604 may include operation 822 depicting receiving the vendor payment channel set including one or more vendor payment channels. For example, FIG. 4, e.g., FIG. 4C, shows vendor payment channel set including one or more vendor payment channels at least partial receiving module 422 receiving the vendor payment channel set (e.g., three vendor payment modalities and three vendor payment options) including one or more vendor payment channels (e.g., a vendor payment option (e.g., casino chips) and two vendor payment modalities (e.g., a casino chip-slot, and a visual cortex recognition system).

Referring again to FIG. 8C, operation 822 may include operation 824 depicting receiving the vendor payment channel set, including one or more vendor payment channels, from the vendor. For example, FIG. 4, e.g., FIG. 4C, shows vendor payment channel set including one or more vendor payment channels at least partial receiving from the vendor module 424 receiving the vendor payment channel set (e.g., one vendor payment modality, e.g., card-embedded microchip), including one or more vendor payment channels (e.g., the one vendor payment modality, e.g., the card-embedded microchip), from the vendor (e.g., the entity receiving compensation for the goods and/or services, e.g., a supermarket, or an online shopping entity, e.g., Amazon.com, or a broker, e.g., craigslist, or a private user on the other side of a virtual transaction, e.g., through an auction site, e.g., eBay).

Referring again to FIG. 8C, operation 822 may include operation 826 depicting receiving the vendor payment channel set, including one or more vendor payment channels, from a channel set manager. For example, FIG. 4, e.g., FIG. 4C, shows vendor payment channel set including one or more vendor payment channels at least partial receiving from a payment channel distributor module 426 receiving the vendor payment channel set (e.g.,

Referring again to FIG. 8C, operation 826 may include operation 828 depicting receiving the vendor payment channel set, including one or more vendor payment channels, from a channel set manager related to the vendor. For example, FIG. 4, e.g., FIG. 4C, shows vendor payment channel set including one or more vendor payment channels at least partial receiving from a payment channel distributor related to the vendor module 428 receiving the vendor payment channel set (e.g., three payment options (e.g., bank gamma debit card, bank delta debit card, corporate credit card), including one or more vendor payment channels, from a channel set manager (e.g., one or more banks, or device manufacturers, e.g., Bank of America, that has a relationship with the vendor that transmits the vendor's payment channel set to anyone that acts). In an embodiment, Bank of America may transmit the vendor payment channel set, including one or more payment channels, in a particular manner that favors payment channels that are beneficial to Bank of America, e.g., a payment option to use a Bank of America credit card, for example.

Referring again to FIG. 8C, operation 826 may include operation 830 depicting receiving the vendor payment channel set, including one or more vendor payment channels, from a channel set manager related to the user. For example, FIG. 4, e.g., FIG. 4C, shows vendor payment channel set including one or more vendor payment channels at least partial receiving from a payment channel distributor related to the client module 430 receiving the vendor payment channel set, including one or more vendor payment channels (e.g., two vendor payment options and two vendor payment modalities), from a channel set manager (e.g., the Apple device marketplace that can be logged into from any Apple product) related to the user (e.g., related to a device carried by the user, e.g., an Apple device, e.g., an Apple iPhone).

Referring now to FIG. 8D, operation 604 may include operation 832 depicting generating the vendor payment channel set, including one or more vendor payment channels. For example, FIG. 4, e.g., FIG. 4C, shows vendor payment channel set including one or more vendor payment channels at least partial generating module 432 generating (e.g., creating all or a portion of) the vendor payment channel set (e.g., one or more payment modalities, e.g., payment by device tap), including one or more vendor payment channels (e.g., a payment modality of device tap).

Referring again to FIG. 8D, operation 832 may include operation 834 depicting generating the vendor payment channel set, including one or more vendor payment channels, from information obtained about the vendor. For example, FIG. 4, e.g., FIG. 4D, shows vendor payment channel set including one or more vendor payment channels generating data at least partially from acquired data regarding the vendor module 834 generating the vendor payment channel set (e.g., three vendor payment modalities and five vendor payment options), including one or more vendor payment channels, from information obtained about the vendor (e.g., information that lists what type of credit cards the vendor accepts, or what type of networks are available, and the like, and constructing a vendor payment channel set from the data that is collected).

Referring again to FIG. 8D, operation 834 may include operation 836 depicting generating the vendor payment channel set, including one or more vendor payment channels, from information obtained about the vendor from an external resource. For example, FIG. 4, e.g., FIG. 4D, shows vendor payment channel set including one or more vendor payment channels generating data at least partially from data regarding the vendor acquired from an external resource module 436 generating the vendor payment channel set (e.g., two vendor payment options (PayPal account, frequent shopper rewards card) and two vendor payment modalities (virtual currency transaction, electronic funds transfer), from information obtained about the vendor from an external resource, e.g., external device 240, e.g., as shown in FIG. 2A (e.g., a user may subscribe to a service that collects data about various vendors and the payment channels used by various vendors, and that service may supply that data to the user, and the data allows the construction of the vendor payment channel set).

In an embodiment, the external resource also may be an intermediate device 230, e.g., intermediate device 232, which may have information regarding payment channels of the vendor, and may provide that information to the user device, e.g., user device 220. In an embodiment, referring to FIG. 2A, user device 220 may receive a portion of data regarding the vendor payment channel from intermediate device 232, and a portion of data regarding the vendor payment channel from intermediate device 234. One, both, or neither of device 232 and 234 may have a relationship with user device 220. For example, device 232 and device 220 may be on the same communication network, or may be a same type of device.

FIGS. 9A-9Q depict various implementations of operation 606 depicting adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set, according to embodiments. Referring now to FIG. 9A, operation 606 may include operation 902 depicting adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set, in order that the user may carry out the transaction with the user payment channel set. For example, FIG. 5, e.g., FIG. 5A, shows application of a client payment channel to at least one vendor payment channel of the acquired vendor payment channel set to facilitate the client carrying out the transaction with the vendor module 502 adapting at least one user payment channel (e.g., a user payment option, e.g., credit card alpha, and a user payment modality, e.g., credit card verification with swipe only) for use with a vendor payment channel (e.g., a vendor payment modality including credit card verification with PIN entry) of the vendor payment channel set (e.g., a set containing the vendor payment channel, and in an embodiment, other vendor payment channels) to facilitate at least a portion of the potential transaction (e.g., purchasing a pair of shoes at a shopping mall), wherein the adapting at least one user payment channel (e.g., a user payment option, e.g., credit card alpha, and a user payment modality, e.g., credit card verification with swipe only) includes one or more of selecting a user payment channel that is present in the vendor payment channel set and interfacing a user payment channel that is absent in the vendor payment channel set, in order that the user may carry out the transaction with the user payment channel set.

Referring again to FIG. 9A, operation 606 may include operation 904 depicting adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set, in order that the user may carry out the transaction with the user payment channel set without being informed of the vendor payment channel or the vendor payment channel set. For example, FIG. 5, e.g., FIG. 5A, shows application of a client payment channel to at least one vendor payment channel of the acquired vendor payment channel set to facilitate the potential transaction without client specific knowledge of the at least one vendor payment channel module 504 adapting at least one user payment channel (e.g., a payment option and a payment modality, e.g., credit card alpha as the payment option and speech recognition as the payment modality) to facilitate at least a portion of the potential transaction (e.g., purchasing groceries at the grocery store), wherein the adapting at least one user payment channel includes one or more of selecting a user payment channel that is present in the vendor payment channel set (e.g., barcode recognition as the payment modality) and interfacing a user payment channel that is absent in the vendor payment channel set, in order that the user may carry out the transaction (e.g., the purchasing of groceries at the grocery store) without being informed of the vendor payment channel or the vendor payment channel set (e.g., the user does not know that the vendor payment channel has a vendor payment modality of barcode recognition, the user merely uses the preferred user payment modality, e.g., speech recognition (e.g., speaking the credit card number into a device), and the user device carries out the adaptation of the received data into a barcode that the vendor can accept, transparently to the user.

Referring again to FIG. 9A, operation 606 may include operation 906 depicting adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set, in order that the user may carry out the transaction with the user payment channel set without additional user interaction. For example, FIG. 5, e.g., FIG. 5A, shows application of a client payment channel to at least one vendor payment channel of the acquired vendor payment channel set to facilitate the potential transaction without client interaction during the potential transaction module 506 adapting at least one user payment channel (e.g., a user payment option, e.g., Gamma Bank branded debit card, and a user payment modality, e.g., card verification with PIN entry) for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set, in order that the user may carry out the transaction with the user payment channel set without additional user interaction (e.g., the user does not know that the vendor payment channel has a vendor payment modality of near-field communication, the user merely uses the preferred user payment modality, e.g., card verification with PIN entry, and the device does not require additional user interaction to select the vendor payment channel and provide the adaptation to the vendor payment modality, if necessary (adaptation may not be necessary if “card verification with PIN entry” is in the vendor payment channel set).

Referring now to FIG. 9B, operation 606 may include operation 908 depicting generating a user payment channel set, said user payment channel set at least partly based on one or more attributes of a user device. For example, FIG. 5, e.g., FIG. 5B, shows client payment channel set at least partly based on user device attributes generating module 508 generating a user payment channel set (e.g., a set of the payment options and payment modalities that are available to the user, e.g., near-field communication (“NFC”) and RFID), said user payment channel set at least partly based on one or more attributes of a user device (e.g., the device needs an NFC transmitter in order to have NFC transmission enabled as a user payment modality that is part of the user payment channel set).

Referring again to FIG. 9B, operation 606 may include operation 910 depicting adapting a user payment channel of the user payment channel set to facilitate at least a portion of the potential transaction, by selecting a user payment channel that is present in the vendor payment channel set. For example, FIG. 5, e.g., FIG. 5B, shows application of a client payment channel taken from the client payment channel set to at least one vendor payment channel of the acquired vendor payment channel set to facilitate the potential transaction module 510 adapting a user payment channel (e.g., a user payment option, e.g., BitCoin virtual currency) to facilitate at least a portion of the potential transaction (e.g., buying digitally encoded Matt & Kim musical performances), by selecting a user payment channel that is present in the vendor payment channel set (e.g., including three vendor payment options, e.g., BitCoin virtual currency, credit card Alpha, and credit card Beta).

Referring again to FIG. 9B, operation 908 may include operation 912 depicting generating the user payment channel set, said user payment channel set at least partly based on one or more attributes of the user device, said user payment channel set including a user payment channel that is present in the vendor payment channel set. For example, FIG. 5, e.g., FIG. 5B, shows client payment channel set at least partly based on user device attributes and at least partly based on vendor payment channel set generating module 512 generating the user payment channel set (e.g., including a user payment option of “indirect device authentication via a device manufacturer network”), said user payment channel set at least partly based on one or more attributes of the user device (e.g., whether the device is currently capable of connecting to the device manufacturer network), said user payment channel set including a user payment channel that is present in the vendor payment channel set.

Referring again to FIG. 9B, operation 908 may include operation 914 depicting generating the user payment channel set, said user payment channel set at least partly based on one or more attributes of the user device, said user payment channel set including a single user payment channel. For example, FIG. 5, e.g., FIG. 5B, shows client payment channel set having a single client payment channel at least partly based on user device attributes generating module 514 generating the user payment channel set (e.g., a user payment option including a corporate credit card, and a user payment modality including one-dimensional bar code), said user payment channel set including a single user payment channel (e.g., a single user payment channel may include a single user payment option, a single user payment modality, or one user payment option and one user payment modality).

Referring again to FIG. 9B, operation 908 may include operation 916 depicting generating the user payment channel set, said user payment channel set at least partly based on one or more user device settings. For example, FIG. 5, e.g., FIG. 5B, shows client payment channel set at least partly based on one or more user device configurations generating module 516 generating the user payment channel set, said user payment channel set at least partly based on one or more user device settings (e.g., the user device settings may be to refuse any user payment channel that requires a wireless network that is secured with anything less than 512-bit encryption, based on a user device setting for extra security).

Referring again to FIG. 9B, operation 916 may include operation 918 depicting generating the user payment channel set, said user payment channel set at least partly based on one or more user device settings that previously were inputted by a user of the user device. For example, FIG. 5, e.g., FIG. 5B, shows client payment channel set at least partly based on one or more client device configurations previously set by a client generating module 518 generating the user payment channel set (e.g., a payment channel set that excludes credit card beta and Gamma Bank debit card from the user payment options), said user payment channel set at least partly based on one or more user device settings that previously were inputted by a user of the user device (e.g., the user may find herself in a position with very little credit limit left on credit card beta, and needs the money in Gamma Bank for rent, so she sets the device to not use those two payment options in the user payment channel set).

Referring again to FIG. 9B, operation 908 may include operation 920 depicting retrieving a list of one or more user payment channel preferences. For example, FIG. 5, e.g., FIG. 5B, shows one or more user payment channel preference designations retrieving module 520 retrieving a list of one or more user payment channel preferences (e.g., a user may set up her preferences to try to use credit card alpha as a payment option, because it has a better rewards program, then credit card beta, then Gamma Bank debit card). User payment channel preferences also may include user payment modality preferences, e.g., a user may de-prioritize payment modalities that use RFID due to lack of security, or de-prioritize payment modalities that use biometric recognition, because of increased inconvenience, or de-prioritize QR code scanning because she doesn't like QR codes.

Referring again to FIG. 9B, operation 908 may include operation 922 depicting generating the user payment channel set, at least partly based on the retrieved list of one or more user payment channel preferences. For example, FIG. 5, e.g., FIG. 5B, shows client payment channel set generating at least partly based on the retrieved one or more client payment channel preference designations retrieving module 522 generating the user payment channel set (e.g., three user payment modalities, e.g., virtual currency transaction, electronic funds transfer, three-dimensional object verification, and two user payment options, e.g., BitCoins, and travelers' checks), at least partly based on the retrieved list of one or more user payment channel preferences (e.g., a list that gets activated when the user leaves the country, to prefer payment options of BitCoins and travelers' checks). Thus, as shown in the previous example, the retrieved list of one or more user payment channel preferences may be context-dependent, e.g., there may be a different list that activates when the user leaves the country, or enters a Starbucks, or enters a particular code on the user's device.

Referring now to FIG. 9C, operation 920 may include operation 924 depicting retrieving the list of one or more user payment channel preferences, said list of one or more user payment channel preferences including one or more of a list of at least one user payment modality preference and a list of at least one user payment option preference. For example, FIG. 5, e.g., FIG. 5B, shows one or more client payment channel preference designations including one or more of at least one client payment modality preference designation and at least one client payment option preference designation retrieving module 524 retrieving the list of one or more user payment channel preferences (e.g., prefer credit card “A” as a user payment option, prefer “check authorization” as a user payment modality), said list of one or more user payment channel preferences including one or more of a list of at least one user payment modality preference (e.g., “prefer check authorization”) and a list of at least one user payment option preference (e.g., “prefer credit card ‘A’”). As is clear from the preceding example, each time “list” is used in this and other applications, it refers to one or more, and in some cases, zero or more, instances of the items of the list.

Referring again to FIG. 9C, operation 920 may include operation 926 depicting retrieving a ranked list of one or more user payment channel preferences, said ranked list of one or more user payment channel preferences including one or more ordered rankings of the one or more user payment channel preferences. For example, FIG. 5, e.g., FIG. 5C, shows one or more client payment channel ordered ranking designations retrieving module 526 retrieving a ranked list of one or more user payment channel preferences (e.g., 1—credit card alpha; 2-credit card beta; 3-instant credit approval; 4-store credit card; 5-corporate credit card), said ranked list of one or more user payment channel preferences including one or more ordered rankings of the one or more user payment channel preferences.

Referring again to FIG. 9C, operation 926 may include operation 928 depicting retrieving the ranked list of one or more user payment channel preferences, said ranked list of one or more user payment channel preferences including an ordered ranking of one or more of at least one user payment modality preference and at least one user payment option preference. For example, FIG. 5, e.g., FIG. 5C, shows one or more client payment modality ordered ranking and client payment option ordered ranking designations retrieving module 528 retrieving the ranked list of one or more user payment channel preferences, said ranked list of one or more user payment channel preferences including an ordered ranking of one or more of at least one user payment modality preference (e.g., 1—credit card verification with swipe only; 2—credit card verification with PIN entry) and at least one user payment option preference (e.g., 1—credit card alpha; 2—credit card beta).

Referring now to FIG. 9D, operation 928 may include operation 930 depicting retrieving the ranked list of one or more user payment channel preferences, said ranked list of one or more user payment channel preferences including an ordered ranking of at least one user payment modality preference and an ordered ranking of at least one user payment option preference, wherein said ordered ranking of at least one user payment modality preference is related to the ordered ranking of at least one user payment modality preference. For example, FIG. 5, e.g., FIG. 5C, shows one or more client payment modality ordered ranking and client payment option related ordered ranking designations retrieving module 530 retrieving the ranked list of one or more user payment channel preferences, said ranked list of one or more user payment channel preferences including an ordered ranking of at least one user payment modality preference (e.g., 1—device authentication via secured wireless network; 2—device authentication via 4G LTE cellular network; 3—device authentication via 3G EDGE cellular network; 4—device authentication via unsecured wireless network) and an ordered ranking of at least one user payment option preference (e.g., 1—credit card alpha; 2—bearer bonds; 3—traveler's checks; 4—foreign currency), wherein said ordered ranking of at least one user payment modality preference is related to the ordered ranking of at least one user payment modality preference (e.g., when credit card alpha is used, device authentication via secured wireless network and device authentication via 4G LTE cellular network are switched in priority, and when “foreign currency” is used “device authentication via 3G EDGE cellular network” is removed from the user payment modality preference).

Referring now to FIG. 9E, operation 924 may include operation 932 depicting retrieving the list of one or more user payment channel preferences, said list of one or more user payment channel preferences including a list of one or more user payment modality preferences that includes a first credit card modality preference and a second credit card modality preference. For example, FIG. 5, e.g., FIG. 5C, shows one or more client payment modality preferences including a first credit card modality preference and a second credit card modality preference that are rank-ordered retrieving module 532 retrieving the list of one or more user payment channel preferences, said list of one or more user payment channel preferences including a list of one or more user payment modality preferences that includes a first credit card modality preference and a second credit card modality preference.

Referring now to FIG. 9F, operation 908 may include operation 934 depicting generating the user payment channel set, said user payment channel set at least partly based on one or more user device settings that are set by a user device manufacturer. For example, FIG. 5, e.g., FIG. 5D, shows client payment channel set at least partly based on one or more user device attributes set by device manufacturer generating module 534 generating the user payment channel set (e.g., a user payment option set that includes “vendor specific gift certificate” and “instant credit approval” and a user payment modality set that includes “use the device manufacturer marketplace to negotiate with the vendor” and “quick response code”), said user payment channel set at least partly based on one or more user device settings (e.g., a setting that includes “prefer to use the device manufacturer marketplace to negotiate with the vendor) that are set by a user device manufacturer (e.g., the user device manufacturer sets the device to prefer to use the device manufacturer marketplace over one or more of the other user payment modalities, which may be set by the user or otherwise determined).

Referring again to FIG. 9F, operation 908 may include operation 936 depicting generating the user payment channel set, said user payment channel set at least partly based on one or more user device settings that are set by an application operating on the user device. For example, FIG. 5, e.g., FIG. 5D, shows client payment channel set at least partly based on one or more user device attributes set by application generating module 536 generating the user payment channel set (e.g., including a user payment modality of “voice recognition”), said user payment channel set at least partly based on one or more user device settings that are set by an application (e.g., the voice recognition software installed on the device) operating on the user device (e.g., a voice-commandable tablet device). In another embodiment, the application may be a device operating system.

Referring again to FIG. 9F, operation 908 may include operation 938 depicting generating the user payment channel set, said user payment channel set at least partly based on one or more input and/or output capabilities of the user device. For example, FIG. 5, e.g., FIG. 5D, shows client payment channel set at least partly based on one or more user device data processing capabilities module 538 generating the user payment channel set (e.g., which may include the user payment modality of near-field communication), said user payment channel set at least partly based on one or more input and/or output capabilities of the user device (e.g., whether the user device has near-field communication capability).

Referring again to FIG. 9F, operation 938 may include operation 940 depicting generating the user payment channel set, said user payment channel set at least partly based on a presence of a bar code reader on the user device. For example, FIG. 5, e.g., FIG. 5D, shows client payment channel set at least partly based on user device bar code data processing capability module 540 generating the user payment channel set, said user payment channel set at least partly based on a presence of a bar code reader on the user device (e.g., a user smartphone with forward and rear facing cameras).

Referring again to FIG. 9F, operation 938 may include operation 942 depicting generating the user payment channel set, said user payment channel set at least partly based on a biometric data collected component on the user device. For example, FIG. 5, e.g., FIG. 5D, shows client payment channel set at least partly based on biometric data processing capability module 542 generating the user payment channel set, said user payment channel set at least partly based on a biometric data collected component of the user device (e.g., if the user device is incapable of reading the user's fingerprint (e.g., because it is cold out and the user has gloves on, or because sweat and/or dirt are jamming the sensors, then biometric payment modalities may be removed from the user payment channel set).

Referring now to FIG. 9G, operation 908 may include operation 944 depicting generating the user payment channel set, said user payment channel set at least partly based on one or more data access levels of the user device. For example, FIG. 5, e.g., FIG. 5E, shows client payment channel set at least partly based on one or more data access authorization capabilities module 544 generating the user payment channel set (e.g., a user payment option set including credit card alpha, credit card beta, and store credit card), said user payment channel at least partly based on one or more data access levels of the user device (e.g., whether the user device has access to one or more databases run by a provider of credit card alpha).

Referring again to FIG. 9G, operation 944 may include operation 946 depicting generating the user payment channel set, said user payment channel set at least partly based on the user device access to a translation table for one or more proprietary vendor codes. For example, FIG. 5, e.g., FIG. 5E, shows client payment channel set at least partly based on data access to one or more proprietary vendor translation codes module 546 generating the user payment channel set (e.g., including a user payment modality set including “2D bar codes”), said user payment channel set at least partly based on the user device access to a translation table for one or more proprietary vendor codes (e.g., the user payment modality set includes “2D bar codes” because the user device has access to the translation table to decode the vendor's 2D barcodes into alphanumeric codes and pricing information).

Referring again to FIG. 9G, operation 944 may include operation 948 depicting generating the user payment channel set, said user payment channel set at least partly based on the user device access to one or more credit card databases that store data regarding the user. For example, FIG. 5, e.g., FIG. 5E, shows client payment channel set at least partly based on data access to one or more client-related credit card databases codes module 548 generating the user payment channel set, said user payment channel set (e.g., including one or more user payment options, e.g., “credit card A”) at least partly based on the user device access to one or more credit card databases that store data regarding the user (e.g., a provider of credit card A stores data about the user).

Referring now to FIG. 9H, operation 908 may include operation 950 depicting selecting a user payment channel from a user payment channel set for use with a vendor payment channel of the vendor payment channel set to facilitate at least a portion of the potential transaction, wherein said selected user payment channel is present in the vendor payment channel set. For example, FIG. 5, e.g., FIG. 5F, shows application of a client payment channel present in the vendor payment channel set to at least one vendor payment channel of the acquired vendor payment channel set to facilitate the potential transaction module 550 selecting a user payment channel from a user payment channel set for use with a vendor payment channel of the vendor payment channel set to facilitate at least a portion of the potential transaction, wherein said selected user payment channel is present in the vendor payment channel set.

Referring again to FIG. 9H, operation 950 may include operation 952 depicting acquiring the user payment channel set. For example, FIG. 5, e.g., FIG. 5F, shows client payment channel set acquisition module 552 acquiring the user payment channel set (e.g., a user payment option or options(e.g., credit card “A” and frequent shopper rewards card), and a user payment modality or modalities (e.g., credit card with e-signature check, and credit card tap with RFID).

Referring again to FIG. 9H, operation 950 may include operation 954 depicting selecting the user payment channel from the acquired user payment channel set for use with the vendor payment channel of the vendor payment channel set to facilitate at least a portion of the potential transaction, wherein said selected user payment channel is present in the vendor payment channel set. For example, FIG. 5, e.g., FIG. 5F, shows application of a client payment channel present in the vendor payment channel set and present in the acquired client payment channel set to at least one vendor payment channel of the acquired vendor payment channel set to facilitate the potential transaction module 554 selecting the user payment channel (e.g., credit card “A” as the user payment option and “credit card tap” as the user payment modality) for use with the vendor payment channel (e.g., the “credit card tap”) of the vendor payment channel set (e.g., five vendor payment modalities and no specified vendor payment options, e.g., credit card tap, credit card verification with swipe only, credit card verification with personal identification number (“PIN”) entry, credit card verification with signature, and one-dimensional bar code) to facilitate at least a portion of the potential transaction (e.g., buying shoes), wherein said selected user payment channel is present in the vendor payment channel set.

Referring again to FIG. 9H, operation 952 may include operation 956 depicting acquiring one or more of at least one user payment modality set and at least one user payment option set. For example, FIG. 5, e.g., FIG. 5F, shows client payment channel set including at least one of a client payment option set and a client payment modality set acquisition module 556 acquiring one or more of at least one user payment modality set (e.g., including voice recognition, device proxy, password only, trusted device voucher, quick response code) and at least one user payment option set (e.g., including corporate credit card, PayPal account, frequent shopper rewards card, nonspecific gift certificate, vendor-specific gift certificate).

Referring again to FIG. 9H, operation 952 may include operation 958 depicting receiving the user payment channel set from a user device. For example, FIG. 5, e.g., FIG. 5F, shows client payment channel set receiving from client device module 558 receiving the user payment channel set (e.g., one user payment option, e.g., credit card alpha, and one user payment modality, e.g., credit card verification with signature) from a user device (e.g., a smartphone).

Referring again to FIG. 9H, operation 952 may include operation 960 depicting receiving the user payment channel set from a device related to the user device. For example, FIG. 5, e.g., FIG. 5F, shows client payment channel set receiving from client-associated device module 560 receiving the user payment channel set (e.g., two user payment options, e.g., Delta bank debit card, and store credit, and two user payment modalities, e.g., fingerprint scan, and indirect device authentication) from a device related to the user device (e.g., a device on the same cellular network provider plan as the device, e.g., a parent's more functional device than a child's limited device).

Referring again to FIG. 9H, operation 952 may include operation 962 depicting receiving the user payment channel set from a device configured to store one or more user payment modalities and/or one or more user payment options. For example, FIG. 5, e.g., FIG. 5F, shows client payment channel set receiving from storage device for one or more of at least one user payment option and at least one user payment modality module 562 receiving the user payment channel set from a device (e.g., a centralized server that communicates with one or more devices, holding a database that contains data about a number of devices and their payment channels) configured to store one or more user payment modalities (e.g., credit card verification with swipe only, credit card verification with personal identification number (“PIN”) entry, credit card verification with signature, credit card verification with physical card proximity using radio frequency identifiers (“RFID”), device tap using near field communication (“NFC”)) and/or one or more user payment options (e.g., credit card alpha, credit card beta, store credit card, fuel rewards card, bank gamma debit card, bank delta debit card, corporate credit card, PayPal account, frequent shopper rewards card, nonspecific gift certificate).

Referring now to FIG. 9I, operation 606 may include operation 964 depicting generating a user payment channel. For example, FIG. 5, e.g., FIG. 5G, shows client payment channel generating module 564 generating a user payment channel (e.g., one or more user payment options (e.g., paying with store credit) and/or one or more user payment modalities (e.g., paying via a wireless network)).

Referring again to FIG. 9I, operation 606 may include operation 966 depicting adapting the generated user payment channel for use with the vendor payment channel of the vendor payment channel set to facilitate at least a portion of the potential transaction. For example, FIG. 5, e.g., FIG. 5G, shows application of generated client payment channel to at least one vendor payment channel of the acquired vendor payment channel set to facilitate the potential transaction module 566 adapting the generated user payment channel (e.g., the one or more user payment options (e.g., paying with store credit) and/or one or more user payment modalities (e.g., paying via a wireless network)) for use with the vendor payment channel (e.g., paying via a wireless network) of the vendor payment channel set (e.g., one or more vendor payment modalities and/or payment options (e.g., payment modalities, e.g., paying via a wireless network, device authentication via cellular network, indirect device authentication via a device manufacturer network, retinal scan, fingerprint scan, speech recognition, voice recognition, device proxy, password only) to facilitate at least a portion of the potential transaction (e.g., buying a pair of shoes from a shoe store).

Referring again to FIG. 9I, operation 964 may include operation 968 depicting generating the user payment set at least partly based on data stored on a user device. For example, FIG. 5, e.g., FIG. 5G, shows client payment channel generating based on client device data module 568 generating the user payment set (e.g., selecting credit card “A” as a payment option) at least partly based on data stored on a user device (e.g., the authentication code for credit card “A” is stored on the user device, which allows it to become part of the user payment set).

Referring again to FIG. 9I, operation 964 may include operation 970 depicting generating one or more user payment options and/or one or more user payment modalities by contacting one or more entities associated with one or more user payment options and/or one or more user payment modalities. For example, FIG. 5, e.g., FIG. 5G, shows client payment channel set generating based on data acquired from entities associated with one or more client payment modalities or one or more client payment options module 570 generating one or more user payment options (e.g., corporate credit card, PayPal account) and/or one or more user payment modalities by contacting one or more entities (e.g., the PayPal central servers) associated with one or more user payment options (e.g., paying via PayPal account) and/or one or more user payment modalities (e.g., paying via device authentication), in order to make sure the device has access and permission to use the PayPal account, or to check and make sure the PayPal account has sufficient funds, or similar actions.

Referring now to FIG. 9J, operation 606 may include operation 972 depicting adapting at least one user payment channel for use with a vendor payment channel of the vendor payment channel set to facilitate at least a portion of the potential transaction, wherein the adapting at least one user payment channel includes selecting a user payment channel that is present in the vendor payment channel set. For example, FIG. 5, e.g., FIG. 5H, shows application of a client payment channel present in the vendor payment channel set to at least one vendor payment channel of the acquired vendor payment channel set to facilitate the potential transaction module 572 adapting at least one user payment channel (e.g., a payment option, e.g., credit card beta, and/or a payment modality (e.g., a credit card verification with signature), which for purposes of illustration, this and other examples show a payment option and a payment modality, even though in other embodiments either one may be used without the other, for use with a vendor payment channel (e.g., a vendor payment option, e.g., credit card beta, and/or a vendor payment modality, credit card verification with signature) of the vendor payment channel set (e.g., one or more vendor payment options (e.g., credit card beta, store credit card, fuel rewards card, bank gamma debit card, bank delta debit card, corporate credit card, PayPal account), and/or one or more vendor payment modalities (e.g., credit card verification with signature, credit card verification with physical card proximity using radio frequency identifiers (“RFID”), device tap using near field communication (“NFC”), device authentication via wireless network, device authentication via cellular network, indirect device authentication via a device manufacturer network), to facilitate at least a portion of the potential transaction (e.g., purchasing a coffee at a coffee shop), wherein the adapting at least one user payment channel (e.g., the payment option, e.g., credit card beta, and/or the payment modality (e.g., a credit card verification with signature), includes selecting a user payment channel (e.g., the payment option, e.g., credit card beta, and/or the payment modality (e.g., a credit card verification with signature) that is present in the vendor payment channel set (e.g., one or more vendor payment options (e.g., credit card beta, store credit card, fuel rewards card, bank gamma debit card, bank delta debit card, corporate credit card, PayPal account), and/or one or more vendor payment modalities (e.g., credit card verification with signature, credit card verification with physical card proximity using radio frequency identifiers (“RFID”), device tap using near field communication (“NFC”), device authentication via wireless network, device authentication via cellular network, indirect device authentication via a device manufacturer network).

Referring again to FIG. 9J, operation 972 may include operation 974 depicting selecting the user payment channel that is present in the vendor payment channel set to facilitate at least a portion of the potential transaction, said facilitating including using the selected user payment channel. For example, FIG. 5, e.g., FIG. 5H, shows selection of the client payment channel present in the vendor payment channel set to facilitate the potential transaction module 574 selecting the user payment channel (e.g., a user payment option, e.g., vendor-specific gift certificate) that is present in the vendor payment channel set (e.g., a set of one or more payment options and/or payment modalities) to facilitate at least a portion of the potential transaction, said facilitating including using the selected user payment channel (e.g., a user payment option, e.g., the vendor-specific gift certificate).

Referring again to FIG. 9J, operation 974 may include operation 976 depicting selecting the user payment channel that is present in the vendor payment channel set to facilitate at least a portion of the potential transaction, said selecting at least partly based on one or more vendor payment channel preferences. For example, FIG. 5, e.g., FIG. 5H, shows selection of the client payment channel present in the vendor payment channel set based on at least one vendor payment channel preference to facilitate the potential transaction module 576 selecting the user payment channel (e.g., a user payment modality, e.g., a card-embedded microchip signal reproduction unit) that is present in the vendor payment channel set (e.g., the vendor payment channel set includes “card-embedded microchip”) to facilitate at least a portion of the potential transaction (e.g., purchasing groceries from a supermarket), said selecting at least partly based on one or more vendor payment channel preferences (e.g., the vendor payment channel prefers using the card-embedded microchip due to security concerns (e.g., the supermarket is in a high-identity theft crime area).

Referring again to FIG. 9J, operation 976 may include operation 978 depicting selecting the user payment channel that is present in the vendor payment channel set to facilitate at least a portion of the potential transaction, said selecting at least partly based on a ranking of one or more payment channels in the vendor payment channel set, said ranking corresponding to a vendor-preferred order of selection of the one or more vendor payment channels. For example, FIG. 5, e.g., FIG. 5H, shows selection of the client payment channel present in the vendor payment channel set at least partly based on at least one vendor-based payment channel ranking to facilitate the potential transaction module 578 selecting the user payment channel that is present in the vendor payment channel set to facilitate at least a portion of the potential transaction (e.g., purchasing movie theater popcorn after being seated at the movie theater), said selecting at least partly based on a ranking of one or more payment channels (e.g., one or more payment options, one or more payment modalities, or a combination thereof) in the vendor payment channel set, said ranking corresponding to a vendor-referred order of selection of the one or more vendor payment channels (e.g., the vendor specifies the order in which the payment channels are to be applied).

Referring again to FIG. 9J, operation 976 may include operation 980 depicting receiving a first portion of the vendor payment channel set including a first one or more vendor payment channels. For example, FIG. 5, e.g., FIG. 5H, shows first portion of vendor payment channel set including a first vendor payment channel receiving module 580 receiving a first portion (e.g., two vendor payment options and two vendor payment modalities) of the vendor payment channel set (e.g., four vendor payment options and four vendor payment modalities) including a first one or more vendor payment channels (e.g., the first portion includes the two vendor payment options, e.g., credit card alpha and credit card beta, and the two vendor payment modalities, e.g., indirect device authentication, credit card verification with signature).

Referring again to FIG. 9J, operation 976 may include operation 982 depicting receiving a second portion of the vendor payment channel set including a second one or more vendor payment channels. For example, FIG. 5, e.g., FIG. 5H, shows second portion of vendor payment channel set including a second vendor payment channel receiving module 582 receiving a second portion (e.g., the remaining two vendor payment options and the remaining two vendor payment channels) of the vendor payment channel set (e.g., the four vendor payment options and the four vendor payment modalities) including a second one or more vendor payment channels (e.g., the second portion includes two more vendor payment options, e.g., corporate credit card, and PayPal, and two more vendor payment modalities, e.g., credit card verification with physical card proximity using radio frequency identifiers (“RFID”), and device tap using near field communication (“NFC”)).

Referring again to FIG. 9J, operation 976 may include operation 984 depicting selecting a user payment channel from the second one or more vendor payment channels. For example, FIG. 5, e.g., FIG. 5H, shows selecting vendor payment channel from second portion of vendor payment channel set module 584 selecting a user payment channel (e.g., selecting a user payment option, e.g., PayPal. and/or a user payment modality (e.g., device tap) from the second one or more vendor payment channels (e.g., the second portion includes two more vendor payment options, e.g., corporate credit card, and PayPal, and two more vendor payment modalities, e.g., credit card verification with physical card proximity using radio frequency identifiers (“RFID”), and device tap using near field communication (“NFC”)).

Referring again to FIG. 9J, operation 984 may include operation 986 depicting selecting the user payment channel from the second one or more vendor payment channels after rejecting one or more of the first one or more vendor payment channels. For example, FIG. 5, e.g., FIG. 5H, shows selecting vendor payment channel from second portion of vendor payment channel set after rejecting one or more vendor payment channels from the first vendor payment channel set module 586 selecting the user payment channel (e.g., selecting a user payment option, e.g., PayPal. and/or a user payment modality (e.g., device tap) from the second one or more vendor payment channels (e.g., the second portion includes two more vendor payment options, e.g., corporate credit card, and PayPal, and two more vendor payment modalities, e.g., credit card verification with physical card proximity using radio frequency identifiers (“RFID”), and device tap using near field communication (“NFC”)) after rejecting one or more of the first one or more vendor payment channels (e.g., the user wants to only use device tap, does not want to swipe a card, so the vendor payment modalities of the first portion are rejected by the user).

Referring now to FIG. 9K, operation 976 may include operation 988 depicting selecting a user payment modality that is present in a user payment modality set to facilitate at least a portion of the potential transaction, said selecting at least partly based on one or more vendor payment modality preferences. For example, FIG. 5, e.g., FIG. 5H, shows selection of a client payment modality present in the vendor payment channel set based on at least one vendor payment modality preference to facilitate the potential transaction module 588 selecting a user payment modality (e.g., device tap) that is present in a user payment modality set (e.g., device tap, credit card with authentication) to facilitate at least a portion of the potential transaction (e.g., purchasing a pastry from a donut shop), said selecting at least partly based on one or more vendor payment modality preferences (e.g., the vendor payment modality preferences may include device tap to facilitate speed through the line).

Referring again to FIG. 9K, operation 976 may include operation 990 depicting selecting a user payment option that is present in a user payment option set to facilitate at least a portion of the potential transaction, said selecting at least partly based on one or more vendor payment option preferences. For example, FIG. 5, e.g., FIG. 5H, shows selection of a client payment option present in the vendor payment channel set based on at least one vendor payment option preference to facilitate the potential transaction module 590 selecting a user payment option (e.g., credit card alpha) that is present in a user payment option set (e.g., which may include credit card alpha, credit card beta, store credit, fuel rewards, and PayPal) to facilitate at least a portion of the potential transaction (e.g., purchasing a new video game at the video game store), said selecting at least partly based on one or more vendor payment option preferences (e.g., the vendor may have a preference for credit card alpha because of a preexisting relationship with a company that provides credit card alpha, e.g., they might take a lower percentage of the sale price when credit card alpha is used, thus the vendor payment channel set may suggest the user of credit card alpha).

Referring now to FIG. 9L, operation 606 may include operation 992 depicting adapting at least one user payment channel for use with a vendor payment channel of the vendor payment channel set to facilitate at least a portion of the potential transaction, wherein the adapting at least one user payment channel includes interfacing a user payment channel that is absent in the vendor payment channel set. For example, FIG. 5, e.g., FIG. 5I, shows application of a client payment channel absent in the vendor payment channel set to at least one vendor payment channel of the acquired vendor payment channel set to facilitate the potential transaction module 592 adapting at least one user payment channel (e.g., wireless network authentication as a user payment modality) for user with a vendor payment channel of the vendor payment channel set (e.g., which includes one or more payment modalities, but not wireless network authentication) to facilitate at least a portion of the potential transaction (e.g., paying for gasoline and a candy bar at a gas station), wherein the adapting at least one user payment channel includes interfacing a user payment channel that is absent in the vendor payment channel set (e.g., the wireless network authentication that is a user payment modality is absent as a vendor payment modality in the vendor payment channel set).

Referring again to FIG. 9L, operation 992 may include operation 994 depicting selecting a vendor payment channel of the vendor payment channel set that is similar to the at least one user payment channel, to facilitate at least a portion of the potential transaction, wherein the adapting at least one user payment channel includes interfacing a user payment channel that is absent in the vendor payment channel set. For example, FIG. 5, e.g., FIG. 5I, shows application of a client payment channel absent in the vendor payment channel set to a vendor payment channel of the acquired vendor payment channel set that is similar to the client payment channel, to facilitate the potential transaction module 594 selecting a vendor payment channel set that is similar to the at least one user payment channel (e.g., device authentication via cellular network, which may be similar to device authentication via wireless network), to facilitate at least a portion of the potential transaction (e.g., paying for your order at a fast-food restaurant), wherein the adapting at least one user payment channel includes interfacing a user payment channel that is absent in the vendor payment channel set).

Referring again to FIG. 9L, operation 992 may include operation 996 depicting carrying out a user portion of the potential transaction using the user payment channel. For example, FIG. 5, e.g., FIG. 5I, shows facilitating a particular portion of the potential transaction using the user payment channel module 596 carrying out a user portion of the potential transaction (e.g., paying for groceries) using the user payment channel (e.g., through voice authentication as a user payment modality, the user speaks his authorization code into the device, and the device recognizes the user, and accesses the user's credit card information and digital image of the user's signature).

Referring again to FIG. 9L, operation 992 may include operation 998 depicting facilitating at least a portion of the potential transaction using the vendor payment channel. For example, FIG. 5, e.g., FIG. 5I, shows facilitating a further portion of the potential transaction using the user payment channel module 598 facilitating at least a portion of the potential transaction using the vendor payment channel (e.g., a vendor payment modality, e.g., credit card authorization with signature, which the device retrieved from memory based on the user's voice authentication, and delivered to the vendor using the vendor's payment modality.

Referring again to FIG. 9L, operation 992 may include operation 901 depicting converting at least a portion of the user payment channel into the vendor payment channel, to facilitate at least a portion of the potential transaction. For example, FIG. 5, e.g., FIG. 5I, shows conversion of the client payment cannel into the vendor payment channel to facilitate the potential transaction module 501 converting at least a portion of the user payment channel (e.g., converting a user modality of “wireless transmission”) into a vendor payment channel (e.g., two-dimensional bar code), e.g., by generating the two dimensional bar code that the vendor needs, based on the data collected from the user through wireless transmission modality, and delivering the two-dimensional bar code to the vendor), to facilitate at least a portion (e.g., buying tools at a hardware store, and using the self-checkout line) of the potential transaction (e.g., buying tools).

Referring now to FIG. 9M, operation 992 may include operation 903 depicting carrying out a user portion of the potential transaction using a user payment option of the user payment channel. For example, FIG. 5, e.g., FIG. 5I, shows facilitating a particular portion of the potential transaction using a client payment option of the client payment channel module 503 carrying out a user portion (e.g., the portion of the transaction that is visible to the user) of the potential transaction (e.g., purchasing groceries) using a user payment option (e.g., credit card alpha) of the user payment channel (e.g., one or more user payment options including credit card alpha).

Referring again to FIG. 9M, operation 992 may include operation 905 depicting converting at least a portion of the data received from the user portion of the potential transaction into data acceptable by a vendor payment option of the vendor payment channel set. For example, FIG. 5, e.g., FIG. 5I, shows at least a portion of data received from the facilitated particular portion of the potential transaction conversion into vendor-acceptable data configured to be used by a vendor payment option of the vendor payment channel set module 505 converting at least a portion of the data received from the user portion (e.g., credit card alpha data) of the potential transaction into data acceptable by a vendor payment option (e.g., PayPal) acceptable by a vendor payment option of the vendor payment channel set (e.g., the credit card alpha data is converted into PayPal account data (e.g., either a temporary account, a user account, or an account related to the user, that the device has access to and can use as an intermediary, e.g., a broker).

Referring again to FIG. 9M, operation 905 may include operation 907 depicting converting first credit card information received from the user portion of the potential transaction into second credit card information acceptable by the vendor payment option of the vendor payment channel set. For example, FIG. 5, e.g., FIG. 5I, shows first credit card data received from the facilitated particular portion of the potential transaction conversion into vendor-acceptable second credit card data configured to be used by a vendor payment option of the vendor payment channel set module 507 converting first credit card information received from the user portion of the potential transaction into second credit card information acceptable by the vendor payment option of the vendor payment channel set.

Referring again to FIG. 9M, operation 907 may include operation 909 depicting converting first credit card information related to a first credit card, said first credit card information received from the user portion of the potential transaction, into second credit card information related to a second credit card, said second credit card information acceptable by the vendor payment option of the vendor payment channel set, by communicating with a provider of the second credit card. For example, FIG. 5, e.g., FIG. 5I, shows first credit card data received from the facilitated particular portion of the potential transaction conversion into vendor-acceptable second credit card data configured to be used by a vendor payment option of the vendor payment channel set at least partially using data from a second credit card provider module 509 converting first credit card information related to a first credit card, said first credit card information received from the user portion of the potential transaction, into second credit card information related to a second credit card, said second credit card information acceptable by the vendor payment option of the vendor payment channel set, by communicating with a provider of the second credit card.

Referring now to FIG. 9N, operation 606 may include operation 911 depicting carrying out a user portion of the potential transaction by using a user payment modality of the user payment channel that is absent in the vendor payment channel set. For example, FIG. 5, e.g., FIG. 5J, shows facilitating a particular portion of the potential transaction using a client payment modality of the client payment channel module 511 carrying out a user portion of the potential transaction by using a user payment modality (e.g., credit card verification with PIN) of the user payment channel set (e.g., one or more user payment options and/or user payment modalities) that is absent in the vendor payment channel set (e.g., the vendor payment channel set does not include credit card verification with PIN, but does allow credit card verification with swipe only, making it less secure, so in this instance, the user payment channel prevents the insecure use of the credit card (e.g., with swipe only), and forces the user to enter the PIN before using the vendor payment channel).

Referring again to FIG. 9N, operation 606 may include operation 913 depicting carrying out a vendor portion of the potential transaction by using a vendor payment modality of the vendor payment channel. For example, FIG. 5, e.g., FIG. 5J, shows at least a portion of data received from the facilitated particular portion of the potential transaction conversion into vendor-acceptable data configured to be used by a vendor payment modality of the vendor payment channel set module 513 carrying out a vendor portion of the potential transaction by using a vendor payment modality (e.g., credit card with swipe only) of the vendor payment channel.

Referring again to FIG. 9N, operation 913 may include operation 915 depicting contacting an external resource configured to use the vendor payment modality of the vendor payment channel. For example, FIG. 5, e.g., FIG. 5J, shows external resource configured to use the vendor payment modality communicating module 515 contacting an external resource (e.g., a device that can generate one-dimensional bar codes on demand) configured to use the vendor payment modality (e.g., reading one-dimensional bar codes) of the vendor payment channel.

Referring again to FIG. 9N, operation 913 may include operation 917 depicting carrying out a vendor portion of the potential transaction using the external resource as an intermediary. For example, FIG. 5, e.g., FIG. 5J, shows facilitating the further portion of the potential transaction with the vendor payment modality at least partly using the external resource as an intermediary module 517 carrying out a vendor portion (e.g., the portion of the transaction involving vendor interaction) of the potential transaction (e.g., purchasing groceries from the grocery store) using the external resource (e.g., a device that has both limited-access wireless and cellular communication, so that the external device, which is known and trusted by the vendor due to a preexisting relationship, can communicate on the vendor network, which is closed off to the user, but the user has cellular access, which the external device also has) as an intermediary (e.g., the external resource contacts the user device using a cellular network, retrieves the payment information, then communicates with the vendor using the vendor payment modality, which is a closed wireless network, that is not in the user payment channel set, because the user device is not a trusted device that has “closed wireless network” for that specific vendor as a user payment modality in the user payment channel set).

Referring again to FIG. 9N, operation 915 may include operation 919 depicting obtaining a list of one or more external resources from a resource manager. For example, FIG. 5, e.g., FIG. 5J, shows one or more external resource identifiers obtaining module 519 obtaining a list of one or more external resources (e.g., devices that may have one or more functionalities (e.g., barcode readers, wireless radios, optical scanners, data access to credit card databases) that may assist in facilitating transactions between vendors and users) from a resource manager (e.g., a central entity that tracks external resources, and which functionalities those external resources have access to).

Referring again to FIG. 9N, operation 915 may include operation 921 depicting contacting an external resource from the list of one or more external resources. For example, FIG. 5, e.g., FIG. 5J, shows external resource having an obtained external resource identifier communicating module 521 contacting an external resource (e.g., a device in the same proximity as the user device, e.g., that has something in common with the user device, e.g., an ability to communicate through near-field communication) from the list of one or more external resources (e.g., a list of devices and whether they have near-field communication capability).

Referring again to FIG. 9N, operation 919 may include operation 923 depicting obtaining a list of one or more external resources that have registered with the resource manager, from the resource manager. For example, FIG. 5, e.g., FIG. 5J, shows one or more registered external resource identifiers obtaining from a resource manager module 523 obtaining a list of one or more external resources (e.g., one or more devices) that have registered (e.g., allowed their identifiers and/or additional information to be published by the resource manager to select entities) with the resource manager (e.g., a central marketplace operator, e.g., the Apple Store, or Google Play).

Referring again to FIG. 9N, operation 919 may include operation 925 depicting obtaining a list of one or more external resources from the resource manager that is associated with the vendor. For example, FIG. 5, e.g., FIG. 5J, shows one or more registered external resource identifiers obtaining from a vendor-associated resource manager module 525 obtaining a list of one or more external resources (e.g., one or more other devices that may assist in the facilitation of a transaction between the user and the vendor) from the resource manager (e.g., a central resource manager for a chain of stores, e.g., a Best Buy resource manager than handles all such situations for Best Buys across the world, and uses the registry of their rewards program to find potential external resources to solicit them for use as external resources) that is associated (e.g., has some sort of relationship with, either contractual or ad-hoc, or is in contact with, or otherwise) with the vendor (e.g., in this case, Best Buy store number 2109 in Pentagon City, Va.).

Referring again to FIG. 9N, operation 919 may include operation 927 depicting obtaining a list of one or more external resources from the resource manager that is associated with one or more of the user and a user device. For example, FIG. 5, e.g., FIG. 5J, shows one or more external resource identifiers obtaining from a user-associated resource manager module 527 obtaining a list of one or more external resources (e.g., devices) from the resource manager (e.g., a resource manager run by a device operating system manufacturer, e.g., if Google were to track all the devices using the Android operating system and using that as a resource list) that is associated (e.g., has provided at least a portion of, or has a contract with, or the user has registered or visited their website, and the like) one or more of the user and a user device.

Referring now to FIG. 9P (there is no FIG. “9O” to avoid confusion with a figure “ninety”), operation 919 may include operation 929 depicting obtaining a list of one or more external resources that have a particular attribute, from the resource manager. For example, FIG. 9, e.g., FIG. 5J, shows one or more external resource identifiers having particular property obtaining module 529 obtaining a list of one or more external resources (e.g., devices) that have a particular attribute (e.g., a barcode reader that can be used to read barcodes to facilitate the transaction with the user and the vendor), from the resource manager (e.g., a central database that manages which devices have which resources for a particular set of devices, e.g., all devices running a particular operating system, e.g., the Android operating system).

Referring again to FIG. 9P, operation 929 may include operation 931 depicting obtaining a list of one or more external resources that have an external resource payment channel set, said external resource payment channel set including one or more payment channels that are present in the vendor payment channel set. For example, FIG. 5, e.g., FIG. 5J, shows one or more external resource identifiers having an external resource payment channel present in the vendor payment channel set module 531 obtaining a list of one or more external resources (e.g., one or more devices) that have an external resource payment channel set (e.g., an external resource payment option, e.g., instant credit approval mechanism), said external resource payment channel set including one or more payment channels that are present in the vendor payment channel set (e.g., that includes three payment options, e.g., nonspecific gift certificate, vendor-specific gift certificate, instant credit approval mechanism, and three payment modalities, e.g., card-embedded microchip, virtual currency transaction, electronic funds transfer).

Referring again to FIG. 9P, operation 929 may include operation 933 depicting obtaining a list of one or more external resources that have the external resource payment channel set, said external resource payment channel set including one or more payment channels that are present in the vendor payment channel set and one or more payment channels that are present in a user payment channel set. For example, FIG. 5, e.g., FIG. 5K, shows one or more external resource identifiers having at least one external resource payment channel present in the vendor payment channel set and at least one external resource payment channel present in a user payment channel set module 533 obtaining a list of one or more external resources (e.g., one or more devices that can be communicated with) that have the external resource payment channel set, said external resource payment channel set including one or more payment channels (e.g., device authentication via a wireless network) that are present in the vendor payment channel set (e.g., which specifies a vendor payment modality that requires a wireless network) and one or more payment channels (e.g., device authentication via a cellular network) that are present in a user payment channel set (e.g., the user payment modalities all require a cellular connection because the user device does not have a wireless network connection).

Referring now to FIG. 9Q, operation 929 may include operation 935 depicting obtaining a list of one or more external resources that are related to the resource manager, from the resource manager. For example, FIG. 5, e.g., FIG. 5K, shows one or more external resource identifiers related to a resource manager obtaining from the resource manager module 535 obtaining a list of one or more external resources (e.g., other devices in the store that have the functionality to bridge the gap between a user payment channel and a vendor payment channel) that are related to (e.g., have registered with) the resource manager (e.g., a marketplace for a particular manufacturer of devices, e.g., an Apple marketplace), from the resource manager (e.g., the marketplace).

Referring now to FIG. 9Q, operation 929 may include operation 937 depicting obtaining a list of one or more external resources that have a particular location, from the resource manager. For example, FIG. 5, e.g., FIG. 5K, shows one or more external resource identifiers having particular position obtaining module 537 obtaining a list of one or more external resources (e.g., other devices that may be able to assist in facilitating the transaction, e.g., a parent's cellular telephone device if it is a child in a comic book store with her device) that have a particular location (e.g., inside the store) from a resource manager (e.g., a home server that tracks where all the family devices are located).

Referring again to FIG. 9Q, operation 929 may include operation 939 depicting obtaining a list of one or more external resources that have a location that is in proximity to one or more of the user and the vendor. For example, FIG. 5, e.g., FIG. 5K, shows one or more external resource identifiers having particular position in proximity to one or more of a client device and a vendor dressage obtaining module 539 obtaining a list of one or more external resources (e.g., one or more smartphones and/or tablets carried by one or more persons in the same store as the user) that have a location (e.g., a position) that is in proximity (e.g., is a particular distance away from, which may be static or changing depending upon conditions) to one or more of the user (e.g., a shopper) and the vendor (e.g., a big-box vendor, e.g., Kohl's).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in an embodiment,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
acquiring an indication of one or more conditions related to a potential transaction between a vendor and a user;
acquiring a vendor payment channel set, said vendor payment channel set including one or more vendor payment channels, at least one of said one or more vendor payment channels including at least one of a vendor payment option and a vendor payment modality; and
adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set.

2. The computationally-implemented method of claim 1, wherein said acquiring an indication of one or more conditions related to a potential transaction between a vendor and a user comprises:
receiving an indication that a user has interacted with an interface of a personal device, said interaction related to the potential transaction between the vendor and the user.

3. (canceled)

4. (canceled)

5. The computationally-implemented method of claim 1, wherein said acquiring an indication of one or more conditions related to a potential transaction between a vendor and a user comprises:
detecting one or more conditions related to the potential transaction between the vendor and the user.

6. (canceled)

7. (canceled)

8. The computationally-implemented method of claim 5, wherein said detecting one or more conditions related to the potential transaction between the vendor and the user comprises:
detecting that the user carried out one or more particular actions.

9. (canceled)

10. (canceled)

11. (canceled)

12. The computationally-implemented method of claim 1, wherein said acquiring an indication of one or more conditions related to a potential transaction between a vendor and a user comprises:
receiving, from a third party contracting from the vendor, an indication of a potential transaction between the vendor and the user.

13. (canceled)

14. (canceled)

15. (canceled)

16. (canceled)

17. (canceled)

18. (canceled)

19. The computationally-implemented method of claim 1, wherein said acquiring a vendor payment channel set, said vendor payment channel set including one or more vendor payment channels, at least one of said one or more vendor payment channels including at least one of a vendor payment option and a vendor payment modality comprises:
acquiring the vendor payment channel set, said vendor payment channel set including a particular vendor payment channel set, said particular vendor payment channel set including a particular vendor payment modality set.

20. (canceled)

21. (canceled)

22. (canceled)

23. (canceled)

24. (canceled)

25. The computationally-implemented method of claim 1, wherein said acquiring a vendor payment channel set, said vendor payment channel set including one or more vendor payment channels, at least one of said one or more vendor payment channels including at least one of a vendor payment option and a vendor payment modality comprises:
receiving the vendor payment channel set including one or more vendor payment channels.

26. (canceled)

27. The computationally-implemented method of claim 25, wherein said receiving the vendor payment channel set including one or more vendor payment channels comprises:
receiving the vendor payment channel set, including one or more vendor payment channels, from a channel set manager.

28. (canceled)

29. (canceled)

30. The computationally-implemented method of claim 1, wherein said acquiring a vendor payment channel set, said vendor payment channel set including one or more vendor payment channels, at least one of said one or more vendor payment channels including at least one of a vendor payment option and a vendor payment modality comprises:
generating the vendor payment channel set, including one or more vendor payment channels.

31. The computationally-implemented method of claim 30, wherein said generating the vendor payment channel set, including one or more vendor payment channels comprises:
generating the vendor payment channel set, including one or more vendor payment channels, from information obtained about the vendor.

32. (canceled)

33. (canceled)

34. (canceled)

35. (canceled)

36. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
generating a user payment channel set, said user payment channel set at least partly based on one or more attributes of a user device; and
adapting a user payment channel of the user payment channel set to facilitate at least a portion of the potential transaction, by selecting a user payment channel that is present in the vendor payment channel set.

37. The computationally-implemented method of claim 36, wherein said generating a user payment channel set, said user payment channel set at least partly based on one or more attributes of a user device comprises:
generating the user payment channel set, said user payment channel set at least partly based on one or more attributes of the user device, said user payment channel set including a user payment channel that is present in the vendor payment channel set.

38. (canceled)

39. The computationally-implemented method of claim 36, wherein said generating a user payment channel set, said user payment channel set at least partly based on one or more attributes of a user device comprises:
generating the user payment channel set, said user payment channel set at least partly based on one or more user device settings.

40. (canceled)

41. The computationally-implemented method of claim 36, wherein said generating a user payment channel set, said user payment channel set at least partly based on one or more attributes of a user device comprises:
retrieving a list of one or more user payment channel preferences; and
generating the user payment channel set, at least partly based on the retrieved list of one or more user payment channel preferences.

42. The computationally-implemented method of claim 41, wherein said retrieving a list of one or more user payment channel preferences comprises:
retrieving the list of one or more user payment channel preferences, said list of one or more user payment channel preferences including one or more of a list of at least one user payment modality preference and a list of at least one user payment option preference.

43. The computationally-implemented method of claim 41, wherein said retrieving a list of one or more user payment channel preferences comprises:
retrieving a ranked list of one or more user payment channel preferences, said ranked list of one or more user payment channel preferences including one or more ordered rankings of the one or more user payment channel preferences.

44. The computationally-implemented method of claim 43, wherein said retrieving a ranked list of one or more user payment channel preferences, said ranked list of one or more user payment channel preferences including one or more ordered rankings of the one or more user payment channel preferences comprises:
retrieving the ranked list of one or more user payment channel preferences, said ranked list of one or more user payment channel preferences including an ordered ranking of one or more of at least one user payment modality preference and at least one user payment option preference.

45. (canceled)

46. (canceled)

47. The computationally-implemented method of claim 36, wherein said generating a user payment channel set, said user payment channel set at least partly based on one or more attributes of a user device comprises:
generating the user payment channel set, said user payment channel set at least partly based on one or more user device settings that are set by a user device manufacturer.

48. The computationally-implemented method of claim 36, wherein said generating a user payment channel set, said user payment channel set at least partly based on one or more attributes of a user device comprises:
generating the user payment channel set, said user payment channel set at least partly based on one or more user device settings that are set by an application operating on the user device.

49. The computationally-implemented method of claim 36, wherein said generating a user payment channel set, said user payment channel set at least partly based on one or more attributes of a user device comprises:
generating the user payment channel set, said user payment channel set at least partly based on one or more input and/or output capabilities of the user device.

50. (canceled)

51. (canceled)

52. The computationally-implemented method of claim 36, wherein said generating a user payment channel set, said user payment channel set at least partly based on one or more attributes of a user device comprises:
generating the user payment channel set, said user payment channel set at least partly based on one or more data access levels of the user device.

53. The computationally-implemented method of claim 52, wherein said generating the user payment channel set, said user payment channel set at least partly based on one or more data access levels of the user device comprises:
generating the user payment channel set, said user payment channel set at least partly based on the user device access to a translation table for one or more proprietary vendor codes.

54. (canceled)

55. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
selecting a user payment channel from a user payment channel set for use with a vendor payment channel of the vendor payment channel set to facilitate at least a portion of the potential transaction, wherein said selected user payment channel is present in the vendor payment channel set.

56. (canceled)

57. (canceled)

58. (canceled)

59. (canceled)

60. (canceled)

61. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
generating a user payment channel; and
adapting the generated user payment channel for use with the vendor payment channel of the vendor payment channel set to facilitate at least a portion of the potential transaction.

62. (canceled)

63. The computationally-implemented method of claim 61, wherein said generating a user payment channel comprises:
generating one or more user payment options and/or one or more user payment modalities by contacting one or more entities associated with one or more user payment options and/or one or more user payment modalities

64. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
adapting at least one user payment channel for use with a vendor payment channel of the vendor payment channel set to facilitate at least a portion of the potential transaction, wherein the adapting at least one user payment channel includes selecting a user payment channel that is present in the vendor payment channel set

65. The computationally-implemented method of claim 64, wherein said adapting at least one user payment channel for use with a vendor payment channel of the vendor payment channel set to facilitate at least a portion of the potential transaction, wherein the adapting at least one user payment channel includes selecting a user payment channel that is present in the vendor payment channel set comprises:
selecting the user payment channel that is present in the vendor payment channel set to facilitate at least a portion of the potential transaction, said facilitating including using the selected user payment channel.

66. The computationally-implemented method of claim Error! Reference source not found., wherein said Error! Reference source not found. comprises:
selecting the user payment channel that is present in the vendor payment channel set to facilitate at least a portion of the potential transaction, said selecting at least partly based on one or more vendor payment channel preferences.

67. (canceled)

68. The computationally-implemented method of claim 66, wherein said selecting the user payment channel that is present in the vendor payment channel set to facilitate at least a portion of the potential transaction, said selecting at least partly based on one or more vendor payment channel preferences comprises:
receiving a first portion of the vendor payment channel set including a first one or more vendor payment channels;
receiving a second portion of the vendor payment channel set including a second one or more vendor payment channels; and
selecting a user payment channel from the second one or more vendor payment channels.

69. The computationally-implemented method of claim 68, wherein said selecting a user payment channel from the second one or more vendor payment channels comprises:
selecting the user payment channel from the second one or more vendor payment channels after rejecting one or more of the first one or more vendor payment channels.

70. The computationally-implemented method of claim 66, wherein said selecting the user payment channel that is present in the vendor payment channel set to facilitate at least a portion of the potential transaction, said selecting at least partly based on one or more vendor payment channel preferences comprises:
selecting a user payment modality that is present in a user payment modality set to facilitate at least a portion of the potential transaction, said selecting at least partly based on one or more vendor payment modality preferences.

71. (canceled)

72. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
adapting at least one user payment channel for use with a vendor payment channel of the vendor payment channel set to facilitate at least a portion of the potential transaction, wherein the adapting at least one user payment channel includes interfacing a user payment channel that is absent in the vendor payment channel set.

73. (canceled)

74. The computationally-implemented method of claim 72, wherein said adapting at least one user payment channel for use with a vendor payment channel of the vendor payment channel set to facilitate at least a portion of the potential transaction, wherein the adapting at least one user payment channel includes interfacing a user payment channel that is absent in the vendor payment channel set comprises:
carrying out a user portion of the potential transaction using the user payment channel; and
facilitating at least a portion of the potential transaction using the vendor payment channel.

75. (canceled)

76. The computationally-implemented method of claim 72, wherein said adapting at least one user payment channel for use with a vendor payment channel of the vendor payment channel set to facilitate at least a portion of the potential transaction, wherein the adapting at least one user payment channel includes interfacing a user payment channel that is absent in the vendor payment channel set comprises:
carrying out a user portion of the potential transaction using a user payment option of the user payment channel; and
converting at least a portion of the data received from the user portion of the potential transaction into data acceptable by a vendor payment option of the vendor payment channel set.

77. (canceled)

78. (canceled)

79. The computationally-implemented method of claim 1, wherein said adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set comprises:
carrying out a user portion of the potential transaction by using a user payment modality of the user payment channel that is absent in the vendor payment channel set; and
carrying out a vendor portion of the potential transaction by using a vendor payment modality of the vendor payment channel.

80. The computationally-implemented method of claim 79, wherein said carrying out a vendor portion of the potential transaction by using a vendor payment modality of the vendor payment channel comprises:
contacting an external resource configured to use the vendor payment modality of the vendor payment channel; and
carrying out a vendor portion of the potential transaction using the external resource as an intermediary.

81. The computationally-implemented method of claim 80, wherein said contacting an external resource configured to use the vendor payment modality of the vendor payment channel comprises:
obtaining a list of one or more external resources from a resource manager; and
contacting an external resource from the list of one or more external resources.

82. (canceled)

83. (canceled)

84. (canceled)

85. The computationally-implemented method of claim 81, wherein said obtaining a list of one or more external resources from a resource manager comprises:
obtaining a list of one or more external resources that have a particular attribute, from the resource manager.

86. (canceled)

87. The computationally-implemented method of claim 85, wherein said obtaining a list of one or more external resources that have a particular attribute, from the resource manager comprises:
obtaining a list of one or more external resources that have the external resource payment channel set, said external resource payment channel set including one or more payment channels that are present in the vendor payment channel set and one or more payment channels that are present in a user payment channel set.

88. (canceled)

89. (canceled)

90. (canceled)

91. (canceled)

92. A computationally-implemented system, comprising:
circuitry for acquiring an indication of one or more conditions related to a potential transaction between a vendor and a user;
circuitry for acquiring a vendor payment channel set, said vendor payment channel set including one or more vendor payment channels, at least one of said one or more vendor payment channels including at least one of a vendor payment option and a vendor payment modality; and
circuitry for adapting at least one user payment channel for use with a vendor payment channel of the vendor payment channel set to facilitate at least a portion of the potential transaction, wherein the adapting at least one user payment channel includes one or more of selecting a user payment channel that is present in the vendor payment channel set and interfacing a user payment channel that is absent in the vendor payment channel set.

93-183. (canceled)
